(19) United States
(12) Patent Application Publication
(10) Pub. No.: US 2026/0294608 A1
(43) Pub. Date: Oct. 1, 2026

(54) SYSTEMS AND DEVICES FOR ORTHODONTIC DEVICES FOR TARGETING THE JUNCTIONAL EPITHELIUM FOR MEDICAMENT DELIVERY AND METHODS THEREOF

(71) Applicant: 3i Biotech, LLC, Lubbock, TX (US)

(72) Inventors: Rohan S.J. Ingrole, Lubbock, TX (US); David Syn, Lubbock, TX (US)

(73) Assignee: 3i Biotech, LLC, Lubbock, TX (US)

(21) Appl. No.: 19/635,751

(22) Filed: Mar. 31, 2026

Related U.S. Application Data
(60) Provisional application No. 63/781,264, filed on Mar. 31, 2025.

(51) Int. Cl. A61C 19/06

(52) U.S. Cl. CPC A61C 19/063

(57) ABSTRACT

A medicament delivery system for delivering therapeutic agents into a gingival crevice proximate to a junctional epithelium. A customized orthodontic device may be configured to conform to a dental anatomy of a patient and to carry a medicament such that, when the customized orthodontic device is seated on one or more teeth, the medicament is moved into a selected gingival crevice. The customized orthodontic device may be configured as a full-arch retainer, a partial-arch retainer, or a single-tooth cap, and may include a reservoir defined between walls for controlled medicament release. In embodiments, a targeting retainer may include one or more targeting holes aligned with selected gingival crevices, and a cartridge having a nozzle, a reservoir, and a piston may deliver the medicament through a selected targeting hole into the selected gingival crevice. The medicament may thereafter be absorbed through the junctional epithelium.

### CROSS-REFERENCE TO RELATED APPLICATIONS

This patent application claims priority to and the benefit of U.S. Provisional Patent Application No. 63/781,264, filed Mar. 31, 2025, titled “SYSTEMS AND DEVICES FOR TARGETING THE JUNCTIONAL EPITHELIUM FOR MEDICAMENT DELIVERY USING ORTHOPEDIC DEVICES AND METHODS”, the entirety of which is hereby incorporated by reference for all purposes.

### TECHNICAL FIELD

The present disclosure relates generally to medicament delivery devices, and more particularly to devices and methods for orthodontic devices for delivery of medicament to the junctional epithelium of the gingival crevice.

### BACKGROUND

Medicaments, such as micronutrient supplements, medications, vaccines, and other therapeutic substances, are essential for maintaining and enhancing human health across various populations. People depend on these medicaments for numerous purposes, ranging from preventing nutritional deficiencies to managing acute and chronic diseases. The broad spectrum of medicament types highlights not only the complexity of human health requirements but also emphasizes the need to create effective delivery systems. These systems must ensure that therapeutic substances efficiently and safely reach their intended targets within the body.

Several delivery systems have been developed to address the administration of medicaments, including oral, intravenous, intramuscular, and transdermal approaches. Oral delivery methods are widely preferred due to their ease of administration and patient compliance. However, oral systems often face challenges such as degradation of active ingredients in the digestive tract, poor absorption rates, and variability in drug bioavailability among individuals. Similarly, intravenous and intramuscular injections, although effective in rapid delivery and absorption, are invasive procedures that can cause discomfort, require skilled personnel, and increase the risk of infections or other complications.

Transdermal systems, designed to deliver medicaments through the skin, offer a less invasive alternative but come with their own limitations. The stratum corneum, the outermost layer of the skin, acts as a significant barrier, restricting the range and amount of therapeutic substances that can effectively pass through. Furthermore, variability in skin properties among individuals can lead to inconsistent dosing and unpredictable therapeutic outcomes. Thus, existing medicament delivery systems, while functional, are frequently hindered by significant drawbacks that affect their efficacy, safety, and patient compliance.

### BRIEF SUMMARY

The present disclosure achieves technical advantages as systems, devices, and methods for orthodontic devices for delivery of medicament to the junctional epithelium of the gingival crevice.

Various embodiments described herein provide customized orthodontic devices, targeting retainers, cartridge-based delivery systems, and methods thereof configured to deliver a medicament into a gingival crevice of a patient for absorption through a junctional epithelium. In embodiments, a customized orthodontic device may be configured to conform to the dental anatomy of the patient and to carry the medicament in association therewith such that, when the customized orthodontic device is seated on one or more teeth of the patient, the medicament may be positioned relative to a selected gingival crevice and released therein. In embodiments, the customized orthodontic device may be configured as a full-arch retainer, a partial-arch retainer, a single-tooth cap, or another custom-fitted orthodontic structure, and the medicament may be carried as a coating, a deposit, a film, a gel, a paste, a medicament seed, or within a reservoir defined by the structure of the customized orthodontic device.

In embodiments, a targeting retainer may be configured with one or more targeting holes aligned with one or more selected gingival crevices, and a cartridge may be configured to deliver the medicament through a selected targeting hole and into the selected gingival crevice. In this manner, the disclosed devices and systems of embodiments may provide controlled alignment, positioning, release, and delivery of the medicament into the gingival crevice to enable targeted absorption through the junctional epithelium.

It is an object of the disclosure to provide methods of delivering a medicament to a gingival crevice of a patient. It is a further object of the disclosure to provide a customized orthodontic device configured for delivering a medicament into a junctional epithelium of a gingival crevice of a patient, and a system for delivering medicament into a junctional epithelium of a gingival crevice of a patient.

In one particular embodiment, a customized orthodontic device configured for delivering a medicament into a junctional epithelium of a gingival crevice of a patient is provided. The customized orthodontic device includes a body configured to conform to a dental anatomy of the patient and to be seated on one or more teeth of the patient and a medicament associated with the body and positioned such that, when the body is seated on the one or more teeth, the medicament is moved into a selected gingival crevice associated with at least one tooth of the one or more teeth for absorption into the patient’s system through a junctional epithelium of the selected gingival crevice.

In another embodiment, a method of delivering a medicament to a gingival crevice of a patient is provided. The method includes positioning a customized orthodontic device relative to one or more teeth of the patient, the customized orthodontic device configured to conform to a dental anatomy of the patient and including a medicament associated therewith, aligning the customized orthodontic device such that the medicament is positioned relative to a selected gingival crevice associated with at least one tooth of the one or more teeth, seating the customized orthodontic device onto the one or more teeth such that the medicament is moved into the selected gingival crevice, and releasing at least a portion of the medicament from the customized orthodontic device into the selected gingival crevice for absorption into the patient’s system through a junctional epithelium of the gingival crevice.

In yet another embodiment, a system for delivering medicament into a junctional epithelium of a gingival crevice of a patient is provided. The system includes a targeting retainer configured to conform to a dental anatomy of the patient and to be seated on one or more teeth of the patient, the targeting retainer including a targeting hole positioned to align with a selected gingival crevice associated with at least one tooth of the one or more teeth. The system also includes a cartridge including a nozzle, a reservoir configured to contain the medicament, and a piston. In embodiments, the nozzle is configured to be inserted through the targeting hole such that the nozzle is positioned to deliver the medicament toward the selected gingival crevice. The system further includes a handle configured to support the cartridge and an actuator configured to engage the piston and to urge at least a portion of the medicament from the reservoir through the nozzle and into the selected gingival crevice for absorption into the patient’s system through a junctional epithelium of the selected gingival crevice.

In still another embodiment, a method of delivering a medicament to a gingival crevice of a patient is provided. The method includes positioning a targeting retainer on one or more teeth of the patient, the targeting retainer configured to conform to a dental anatomy of the patient and including a targeting hole aligned with a selected gingival crevice associated with at least one tooth of the one or more teeth, and positioning a cartridge relative to the targeting hole, the cartridge including a nozzle, a reservoir containing a medicament, and a piston. The method also includes inserting the nozzle of the cartridge through the targeting hole such that the nozzle is positioned to deliver the medicament toward the selected gingival crevice and actuating the cartridge to advance the piston and expel at least a portion of the medicament from the reservoir through the nozzle and into the selected gingival crevice for absorption into the patient’s system through a junctional epithelium of the selected gingival crevice.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1A shows a perspective view of a portion of an oral cavity illustrating a representative gingival crevice adjacent to a tooth.

FIGS. 1B-1E show exemplary anatomy of a gingival crevice in the gingiva for targeting deposition of medicament in accordance with embodiments of the present disclosure.

FIGS. 1F-1H shows various examples of medicament seed insertion into the gingival crevice in accordance with embodiments of the present disclosure.

FIG. 1I illustrates a front view of the gingival crevice anatomy of a patient that may be targeted for medicament deposition in accordance with embodiments of the present disclosure.

FIG. 2 shows a diagram illustrating an example of a customized orthodontic device configured for medicament delivery to a gingival crevice of a patient in accordance with embodiments of the present disclosure.

FIG. 3 shows a diagram illustrating an example operational sequence showing one approach for using an orthodontic device to deliver medicament to a gingival crevice of a patient for absorption through a junctional epithelium in accordance with embodiments of the present disclosure.

FIG. 4 shows a diagram illustrating an example of a customized orthodontic device configured for delivery of medicament to a gingival crevice of a patient for absorption through a junctional epithelium in accordance with embodiments of the present disclosure.

FIG. 5 illustrates another embodiment of a customized orthodontic device configured with functionality for delivery of medicament to a gingival crevice of a patient for absorption through a junctional epithelium in accordance with embodiments of the present disclosure.

FIG. 6 is a diagram illustrating another embodiment of devices configured with functionality for delivery of medicament to a gingival crevice of a patient for absorption through a junctional epithelium in accordance with embodiments of the present disclosure.

FIG. 7 is a diagram illustrating a targeting device configured with functionality for delivery of medicament to a gingival crevice of a patient for absorption through a junctional epithelium in accordance with embodiments of the present disclosure.

FIG. 8 is a diagram illustrating an example of a cartridge configured to deliver medicament to a gingival crevice of a patient for absorption through a junctional epithelium in accordance with embodiments of the present disclosure.

FIG. 9 illustrates front views of the cartridge configured to deliver medicament to a gingival crevice of a patient for absorption through a junctional epithelium in accordance with embodiments of the present disclosure.

FIG. 10 illustrates an embodiment of a system configured for delivery of a medicament to a gingival crevice of a patient for absorption through a junctional epithelium in accordance with embodiments of the present disclosure.

FIG. 11 illustrates an example of operations of a device for delivery of a medicament to a gingival crevice of a patient for absorption through a junctional epithelium in accordance with embodiments of the present disclosure.

FIG. 12 shows a high-level flow diagram of operations for delivery of medicament into the gingival crevice for absorption through the junctional epithelium in accordance with embodiments of the present disclosure.

FIG. 13 shows another high-level flow diagram of operations for delivery of medicament into the gingival crevice for absorption through the junctional epithelium in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features de-scribed herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

It is noted that the oral cavity contains multiple gingival crevices, each providing an advantageous site for depositing medicament seeds that can dissolve and release their medicaments. By targeting these gingival crevices, and particularly the junctional epithelium located deep within them, the present disclosure leverages the high permeability of this anatomical region and its close proximity to connective tissue populated by immune cells. This approach not only improves bioavailability but also has the potential to reduce systemic side effects commonly associated with oral or injectable medicament delivery.

The inventors have found that the field of medicament delivery has seen a variety of routes, methods and devices developed over the years. The inventors have also found that these methods and devices may be employed to deliver a range of medicaments, including but not limited to nutrients, micronutrients, antibiotics, antigens, anti- inflammatory agents, antimicrobial agents, antibodies, steroids, DNA, and minerals. The delivery of these medicaments may be targeted to specific areas of the body to maximize their efficacy and minimize potential side effects. Additionally, the route of medicament delivery can have a significant impact on its pharmacokinetics and pharmacodynamics.

The route of delivery and the characteristics of the medicament itself, in its various forms may be factors that determine the amount that can be delivered, bioavailability, biodistribution, and the duration of circulation within the body. These factors are important in determining the choice of route of delivery for a given medicament. However, other concerns such as safety, efficacy, ease of administration, whether self-administered or given by a health care professional, costs, ease of manufacturing and stability of the medicament in the form determined by the route, also play significant roles. Matching the individual characteristics of the medicament to be delivered, in its various forms, to the routes through which it can be delivered, to accomplish the highest safety, efficacy, ease of administration, reduction of costs, and ease of manufacturing is a significant goal in developing novel medicament delivery systems. A novel device and route to deliver medicament to a space that has not been previously used for medicament delivery, the Gingival Crevice (GC), able to overcome many of the limitations of the commonly known routes of delivery, is described herein.

The classification of routes for administration of medicament is usually determined by the location of application. The two most commons routes of medicament delivery are broadly categorized as enteral (through the gastrointestinal tract), and parenteral (not enteral). The enteral route involves absorption of the medicament through the gastrointestinal (GI) tract. Administration can be through ingestion or other access to the GI tract such as tubes or catheters or insertion into the rectum. The parenteral route refers to any route that is not enteral. Parenteral administration can involve injection of medicament via a needle and syringe, or by insertion of an indwelling catheter into a body cavity, or by application of medicament on a surface of the body. Parenteral routes are often described with prefixes such as epi- (epidural), sub- (subcutaneous), intra- (intramuscular), extra- (extra-amniotic), peri- (perivascular) and trans- (transdermal or transmucosal) depending on where the medicament is deposited and how it is being taken up by the body.

The inventors have found that the enteral route is advantageous in that it is available for most individuals, is convenient, self-administrable, allows for systemic distribution and is often cost-effective. The disadvantages of the enteral route include the higher dosage of medicament required due to the barriers inherent to the GI tract. These barriers include, but are not limited to, the degradative acidic environment of the stomach, the first-pass effect (reductive filtration, enzymatic, and proteolytic process enacted through the liver during digestive processes resulting in significant removal of administered drug and thus reduced bioavailability for systemic circulation), and interactions with other medicaments. These disadvantages are magnified in situations where absorption has been surgically altered at the same time requirements for micronutrients are increased such as in the bariatric surgical population, or in situations where the enteral route is not available.

The inventors have found that the parenteral route is advantageous in that it can be rapid, can be delivered directly into the blood stream, can avoid the first-pass effect, can deliver much higher amounts of medicaments, can be utilized when the enteral route is not available and can be easily applied topically. The disadvantages of the parenteral route are that it can be painful, inconvenient, expensive, locally irritating, relatively difficult to store in some forms and may require administration by a health care professional. Both the enteral and parenteral routes of medicament delivery have limitations.

The GC, also known as the Gingival Sulcus, is a unique space that has special characteristics dictated by the environment it is in. The nature and the location of the GC requires it to have unique physical and biological characteristics as it is the barrier to the external environment and is under constant assault requiring it to be highly immunologically active. To facilitate this immune surveillance, the specialized mucosa of the GC is highly permeable allowing for rapid cellular motility and transport. The inventors have found that these unique characteristics make the GC an ideal target for immunomodulation. In addition, the high permeability of the GC also makes it an ideal site for medicament delivery, overcoming some of the limitations of both the enteral and commonly known parenteral routes. A novel device to deliver medicament to the GC, such as the devices described herein, can take advantage of these unique characteristics.

The GC is a dynamic fluid filled moat which is the interface between a tooth and the surrounding gingival tissue. It is a potential space filled with food debris, endogenous and exogenous cells, and chemicals. Any individual that has flossed is familiar with the characteristics of this potential space. In the deepest recesses of the GC is the Junctional Epithelium (JE) tissue which is a stratified squamous epithelium that resembles the oral epithelium but differs in some important ways. It is the only discontinuous epithelium layer in the body. The JE is the final barrier between what is inside the body and what is outside. Unlike the rest of the oral mucosa, cells of the JE are non-keratinized, have a high turnover rate, and have wide intercellular spaces which gives the JE its characteristic high permeability. The inventors have found that this high permeability of the JE makes it susceptible as a pathway for metabolic products of plaque bacteria, however this high permeability also makes it an ideal site for rapid absorption of medicament that are delivered to the GC. As the GC is the interface between the inside of the body and the outside world it is a highly immunological space. The JE expresses several cytokines and chemokines and is penetrated by neutrophil and Langerhans cells (specialized dendritic cells). The JE plays a key role in the innate immune system and in the overall health of gingival mucosa. The JE located at the interface between the gums and tooth surface, is a mucosal site. Additionally, the underlying connective tissue of the JE is vascularized. The vascularization of the underlying tissue helps to support immune responses and tissue repair in the gingiva. This vascularization enhances the JE’s immune response by allowing immune cells to be recruited quickly during infection. This biological nature of the JE is crucial for maintaining its barrier function, immune defense, and periodontal health. The inventors have found that, as an active mucosal site and providing access to blood vessels in the underlying connective tissue, the JE can provide an advantage of inducing both mucosal and systemic responses, which makes the GC, specifically the JE of the GC, an ideal space for immunomodulation.

There are currently no methods for accessing the GC to deliver medicament to the deepest recesses to exploit the immune and absorptive potential of the junctional epithelium in the gingival crevice. A novel device designed to accurately target the deep GC, such as the devices and methods described herein, may take advantage of the unique characteristics of this space to safely, efficiently, consistently, quantifiably, painlessly and effectively deliver medicament through a novel route for systemic circulation and for immunomodulation.

This novel route of medicament delivery has not been previously described. It would fall under the general category of parenteral route of delivery. Specifically, such a route for medicament delivery may be characterized as a transmucosal route of delivery (diffusion through a mucosal membrane). Examples of transmucosal routes include insufflation (snorting of cocaine), sublingual (under the tongue) and sublabial (between the lips and gingiva), buccal (inner cheeks), and rectal (mucosal absorption but considered enteral as it is absorbed through the gastrointestinal tract). The JE of the gingival crevice, however, deserves special attention in that it is being utilized, in the present disclosure, for medicament delivery in a novel previously undescribed manner with a previously undescribed device. Unlike other transmucosal routes of delivery, the medicament is not placed into an open space, it is being wedged into a potential space that requires a novel device to deliver it. This potential space is the gingival crevice. The Merriam-Webster dictionary defines crevicular as: “of, relating to, or involving a crevice and especially the gingival crevice.” As such, the inventors have coined the phrase “Intra-crevicular route”. The route of delivery is thus referred to as the “INTRACREVICULAR ROUTE” of delivery. As the Junctional Epithelium is also unique and is the only epithelium in the body that is discontinuous, the route can also be referred to as the “TRANS-JUNCTIONAL ROUTE” and the delivery of medicaments can be appropriately referred to as “TRANS-JUNCTIONAL DELIVERY”.

The proposed novel route of junctional epithelium of the gingival crevice is unique and can be utilized to deliver an array of medicaments each with its unique therapeutic utility. The scope of some of the medicaments, their current challenges in terms of achieving therapeutic effect, and the potential of the JE as an alternative novel route for their delivery are discussed herein. Vaccines play a crucial role in protecting public health by preventing the spread of infectious diseases. They stimulate the immune system to recognize and fight specific pathogens, without causing the disease itself. This not only helps individuals build immunity but also reduces the overall prevalence of diseases, contributing to herd immunity. Vaccines have led to the eradication or significant reduction of deadly diseases like smallpox and polio. They are essential for controlling outbreaks, reducing healthcare costs, and improving life expectancy globally. Conventional vaccine delivery methods, including intramuscular (IM), subcutaneous (SC), and oral routes, have proven effective but come with significant limitations, especially in their ability to induce both systemic and mucosal immune responses. These routes are critical for preventing various infectious diseases, but each has its own set of challenges that affect their overall effectiveness, particularly for certain pathogens. IM and SC routes are commonly used for vaccines, especially for diseases requiring strong systemic immunity, such as hepatitis or tetanus. These methods ensure that the vaccine enters the bloodstream, where a systemic immune response can be triggered. However, the IM and SC routes fail to induce significant mucosal immunity, which is essential for defending against infections at incursion points like the respiratory or gastrointestinal tracts. Most viruses enter the human body through mucosal surfaces, such as the nose, mouth, eyes, and respiratory or gastrointestinal tracts. These sites serve as primary entry points for many pathogens thus it would be advantageous for a delivery route to allow for an induction of an antibody response at these mucosal sites in sync with systemic immune response, so that the attack from viruses can be thwarted at their point of entry. For diseases that primarily affect mucosal surfaces (e.g., influenza or enteric diseases), the conventional routes could be less effective because they might fail to engage the immune systems located in mucosal tissues. Vaccines that are delivered to the JE of the GC could overcome the limitations of conventional vaccine delivery routes and confer both systemic and mucosal immunity.

Micronutrient malnutrition affects over two billion individuals globally, with a particularly acute impact on children under five, more than half of whom suffer from vitamin and mineral deficiencies. Novel methods of micronutrient delivery, such as described herein, may help solve this problem. Micronutrients, which are not endogenously produced in the body—with the exception of vitamin D—must be obtained through dietary intake. In the United States alone, vitamin D deficiency is prevalent in 8% of the population, a figure that is likely much higher on a global scale. Essential minerals such as Iron, Zinc, and Iodine play a central role in preventing anemia, bolstering immune function, and supporting healthy cognitive development in infants. Similarly, Vitamin A is imperative for maintaining healthy eyesight and immune function, preventing blindness, and mitigating the risk of death from infections like measles and diarrhea.

Obese populations are particularly susceptible to micronutrient deficiencies due to factors such as fat sequestration, inflammation-associated malabsorption in the gut, and hyperinsulinemia-associated urinary excretion. These deficiencies are exacerbated with increasing obesity, especially among premenopausal obese females. The prevalence of morbid obesity and the corresponding rise in bariatric surgeries—recognized as the sole effective long-term weight loss treatment—further compound the issue. In 2022, the United States saw 280,000 bariatric procedures, reflecting a growing trend. Post-surgery, individuals experience a marked reduction in micronutrient absorption due to alterations in the stomach and small intestine, necessitating lifelong supplementation of oral vitamins and minerals to prevent deficiencies and associated diseases such as Wernicke’s encephalopathy.

The conventional method of micronutrient supplementation for individuals who have undergone bariatric surgery typically involves the intake of a large number of pills, often exceeding twenty, multiple times throughout the day. This regimen, while effective in theory, presents a considerable burden to the individual. The sheer volume of pills and the frequency of administration can be overwhelming, leading to a decline in adherence over time. This lack of adherence can have serious health implications, as these individuals are already at a heightened risk of micronutrient deficiencies due to the nature of their surgical procedures.

Alternative methods of supplementation have been explored, but these too present their own set of challenges. Transdermal patches, for instance, have been introduced as a less invasive option. However, these patches have not demonstrated the same level of efficacy as oral supplementation. Clinical trials conducted by independent investigators have shown that these patches are considerably less effective than oral supplementation, resulting in higher rates of micronutrient deficiency when used as the sole method of supplementation.

Other forms of supplementation, such as subcutaneous or intramuscular injections, while effective, are not without their drawbacks. These methods can be quite costly, putting them out of reach for many individuals. Additionally, they can be painful, further discouraging adherence to the supplementation regimen.

Nasal sprays and sublingual applications have also been explored as alternative methods of supplementation. While these methods have been shown to be effective, they are limited in their scope. They are typically used for the delivery of specific vitamins, such as vitamin B12, and cannot provide a comprehensive solution for micronutrient supplementation. Furthermore, these methods can be quite expensive, further limiting their accessibility and use.

Other delivery methods, such as medicated floss, have proven to be less than ideal. The primary issue with these methods is that they fail to effectively deposit the micronutrients in the target area, which is the junctional epithelium of the gingival crevice. This is due to the fact that the medicament, or the substance carrying the micronutrients, is often scraped off outside of the gingival crevice during the process of flossing. As a result, a majority of the micronutrients do not reach the intended area and are instead wasted. This inefficiency in delivery not just reduces the effectiveness of the supplementation but also leads to wastage of the medicament. Moreover, these methods are often complex and require a high level of individual compliance for effectiveness. For instance, the use of medicated floss requires the individual to floss regularly and correctly, which can be a challenge for many. This complexity and the associated difficulty in maintaining regular use can lead to poor compliance, further reducing the effectiveness of these methods.

Pharmaceutical medications have greatly influenced health systems by enhancing treatment results and increasing life expectancy. They have changed the management of chronic conditions, including diabetes and hypertension, enabling people to lead healthier lives. Medications have transformed previously deadly conditions into more manageable ones, lowering death rates. Furthermore, the emergence of personalized medicine and targeted therapies has resulted in more efficient treatments, particularly in cancer treatment. Hormonal treatments have significantly changed lives, particularly for those with endocrine issues or experiencing life phases like menopause or hormone therapy post-surgery. For instance, thyroid hormone replacements assist in controlling hypothyroidism, whereas insulin therapy has been crucial for individuals with diabetes. Hormone replacement therapy (HRT) has reduced menopausal symptoms like hot flashes and mood changes, enhancing the quality of life for numerous women. These medications have enabled individuals to live healthier, more active lifestyles, offering relief from severe symptoms and facilitating improved control of chronic illnesses. In the end, pain medications and hormones have allowed individuals to take charge of their health, positively impacting their mental and physical wellness. Nonetheless, the method of drug delivery poses various challenges that can influence treatment efficacy and patient adherence. For instance, oral medications frequently encounter challenges with absorption and bioavailability, as they may be degraded in the digestive tract, diminishing their effectiveness. Injections, although more efficient for direct delivery, may lead to pain, discomfort, and local side effects such as swelling or irritation. Methods such as transdermal patches or sublingual tablets could enhance patient adherence by providing less frequent dosing, but they might not be appropriate for every kind of medication. Reaching controlled and precise drug release continues to pose a challenge, particularly with oral or transdermal techniques, and ensuring stability along with appropriate storage conditions complicates matters further. In addition, guaranteeing accurate drug administration to the designated location, such as in targeted therapies for cancer, remains a significant hurdle. These factors make choosing the right route of administration crucial for successful treatment.

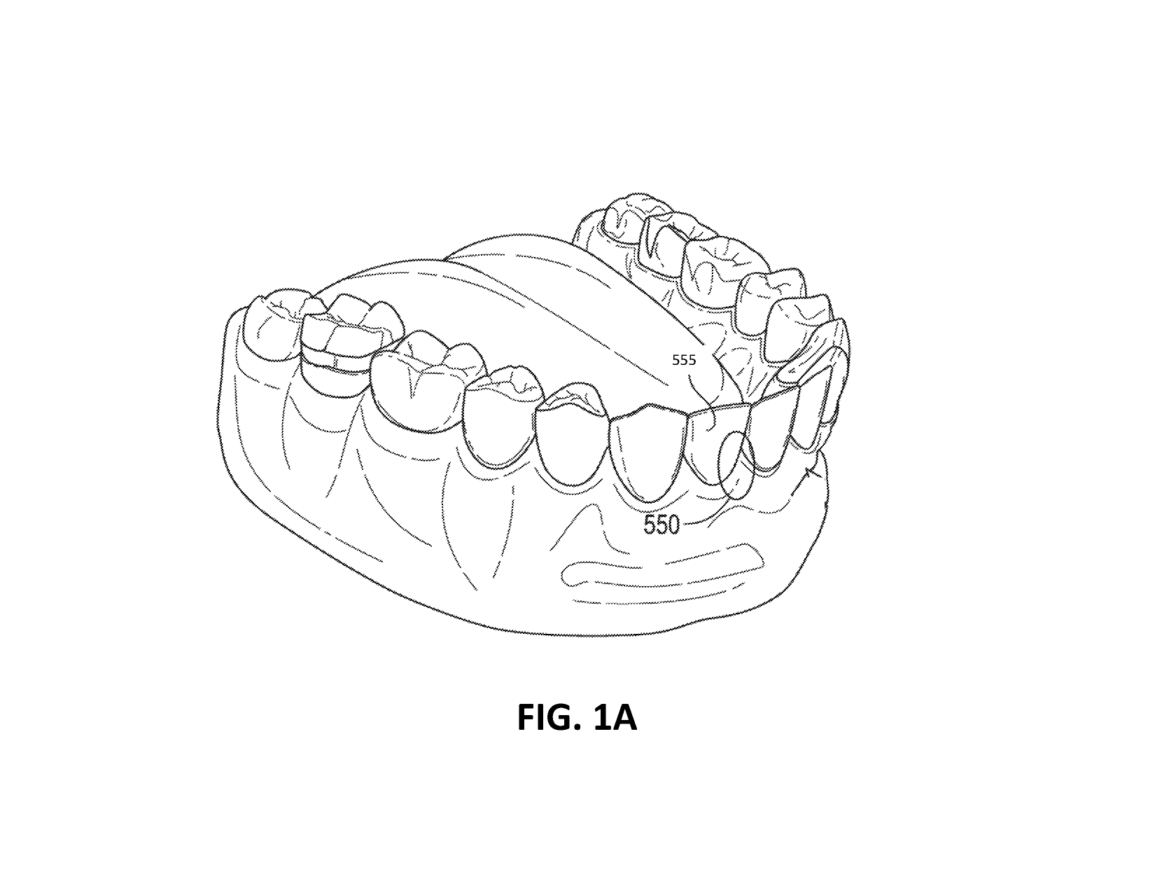

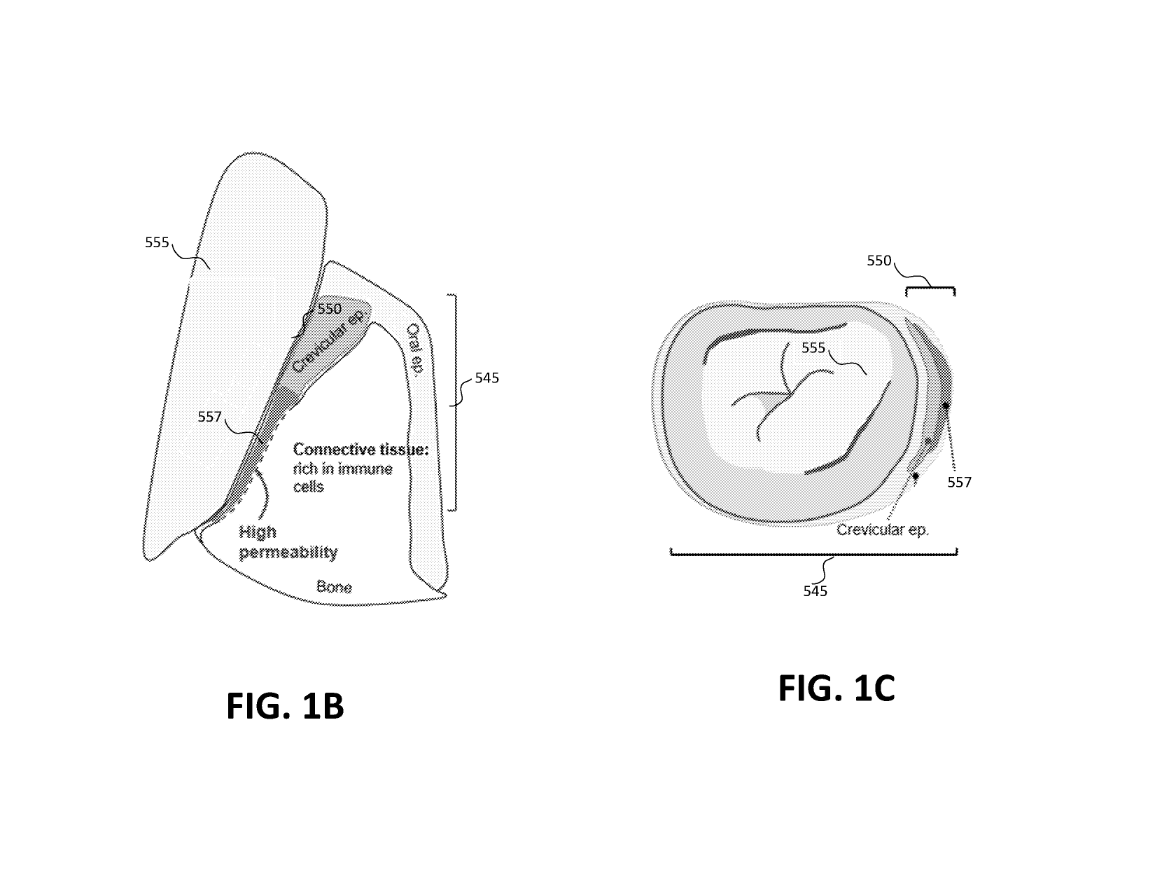

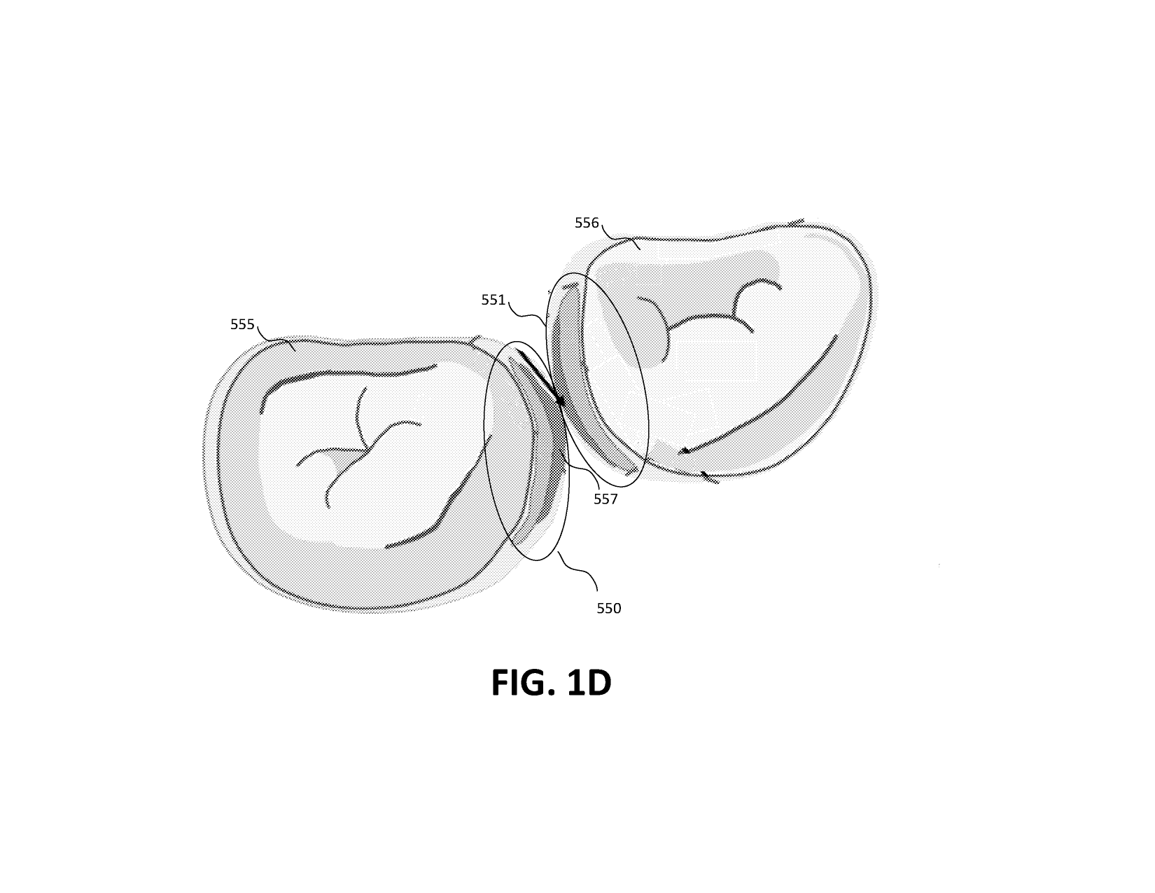

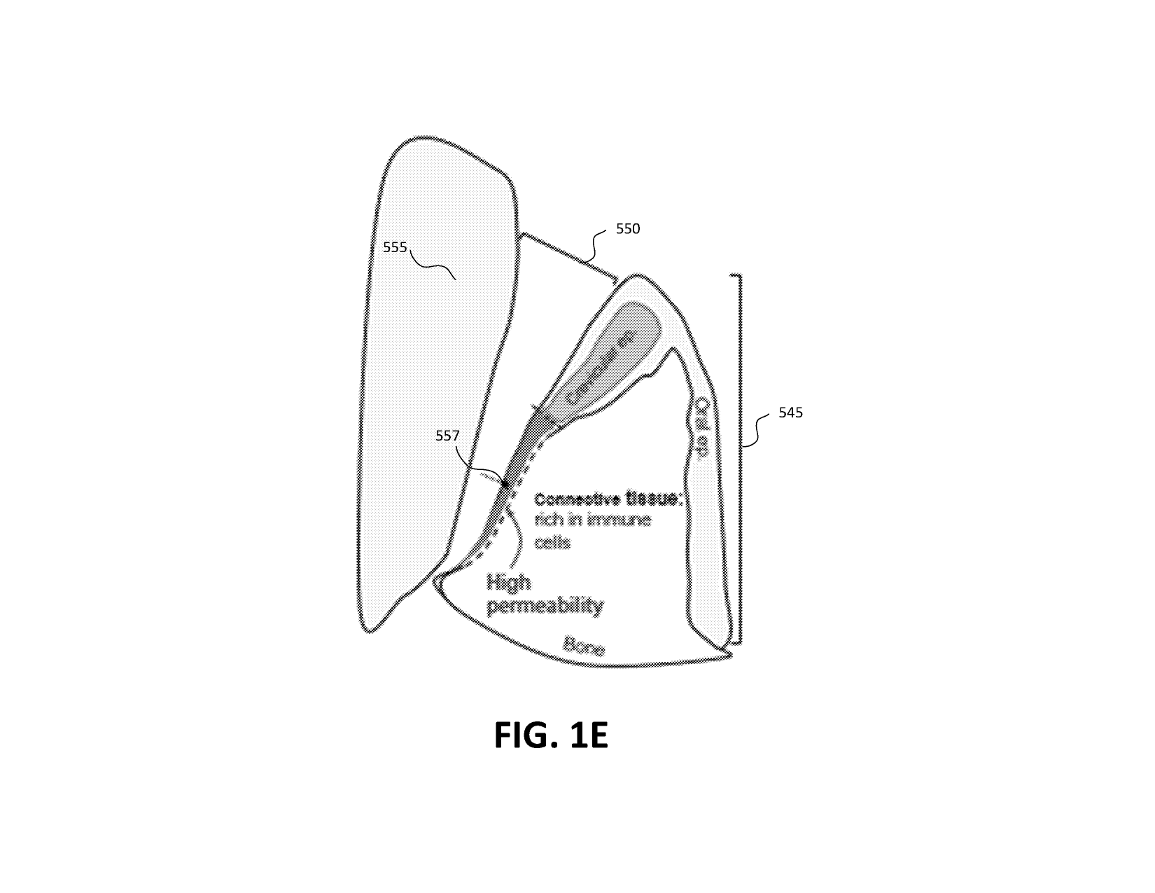

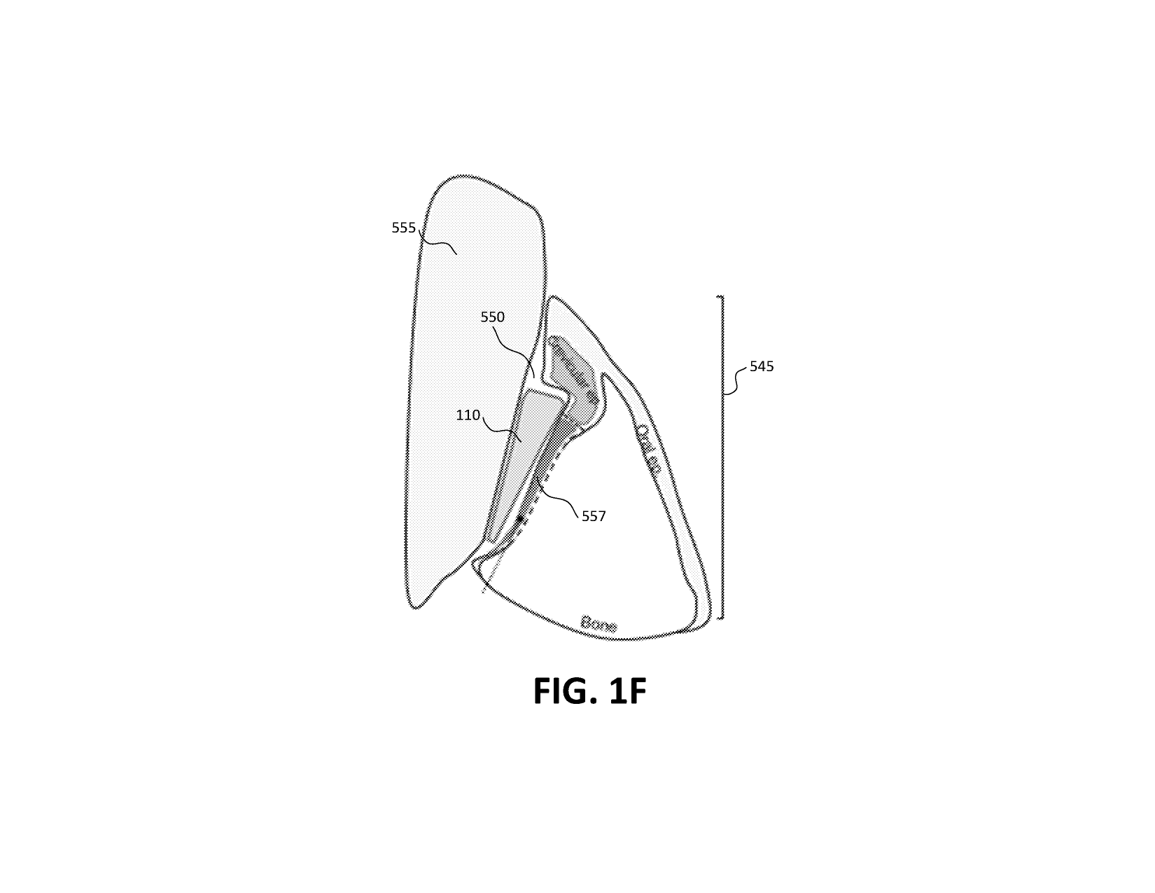

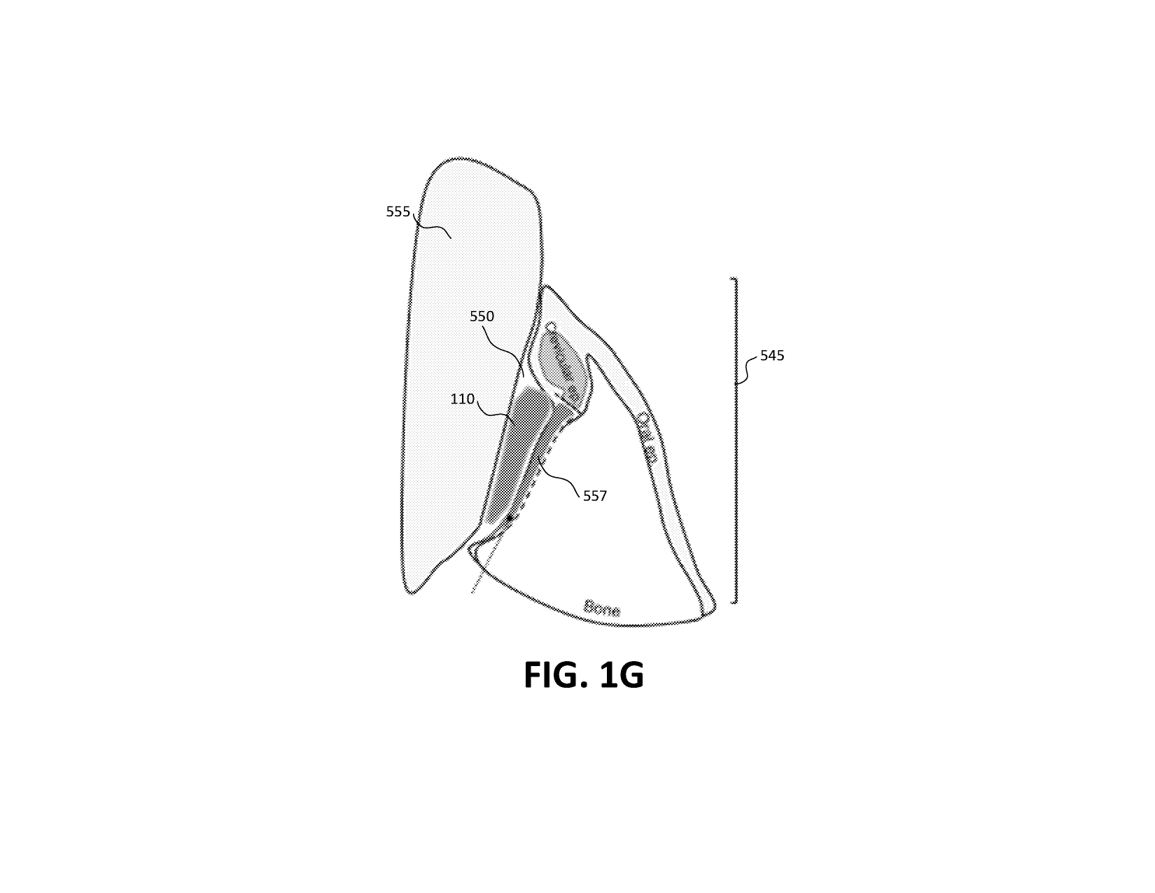

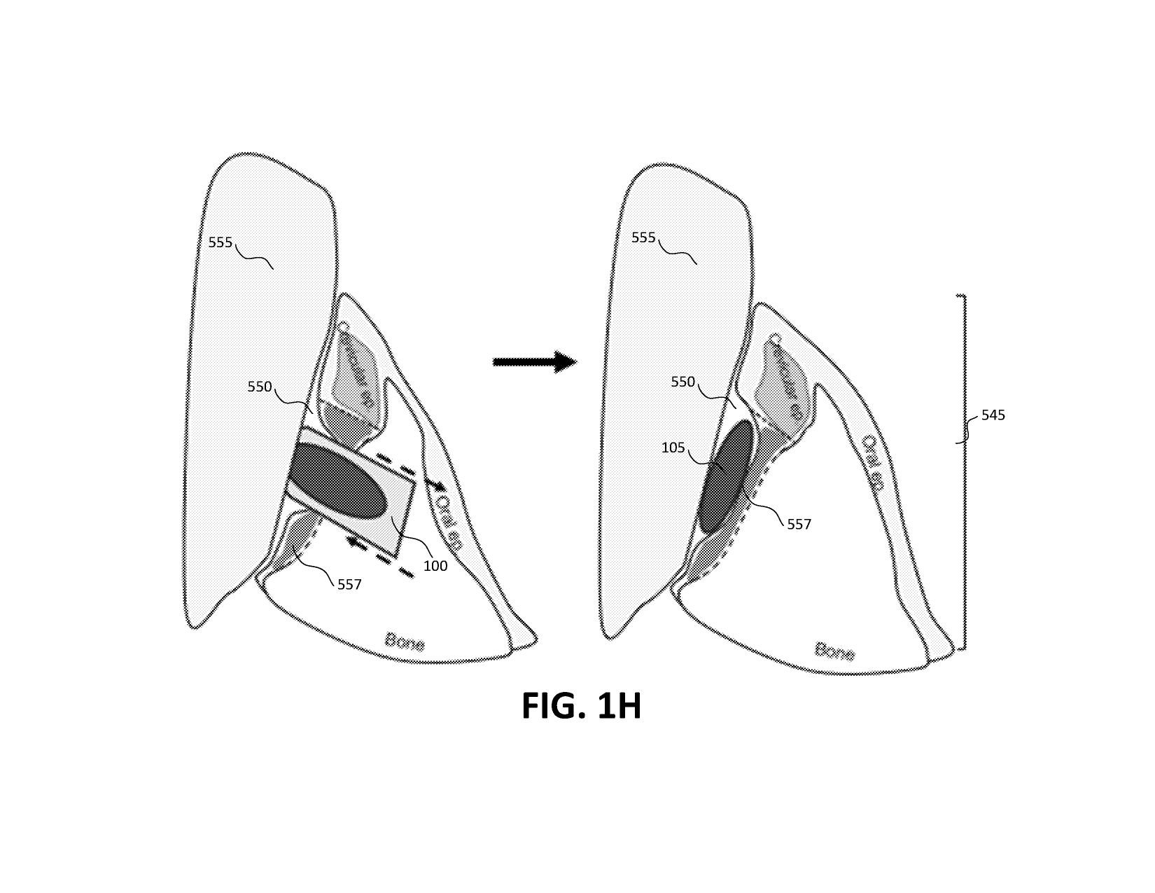

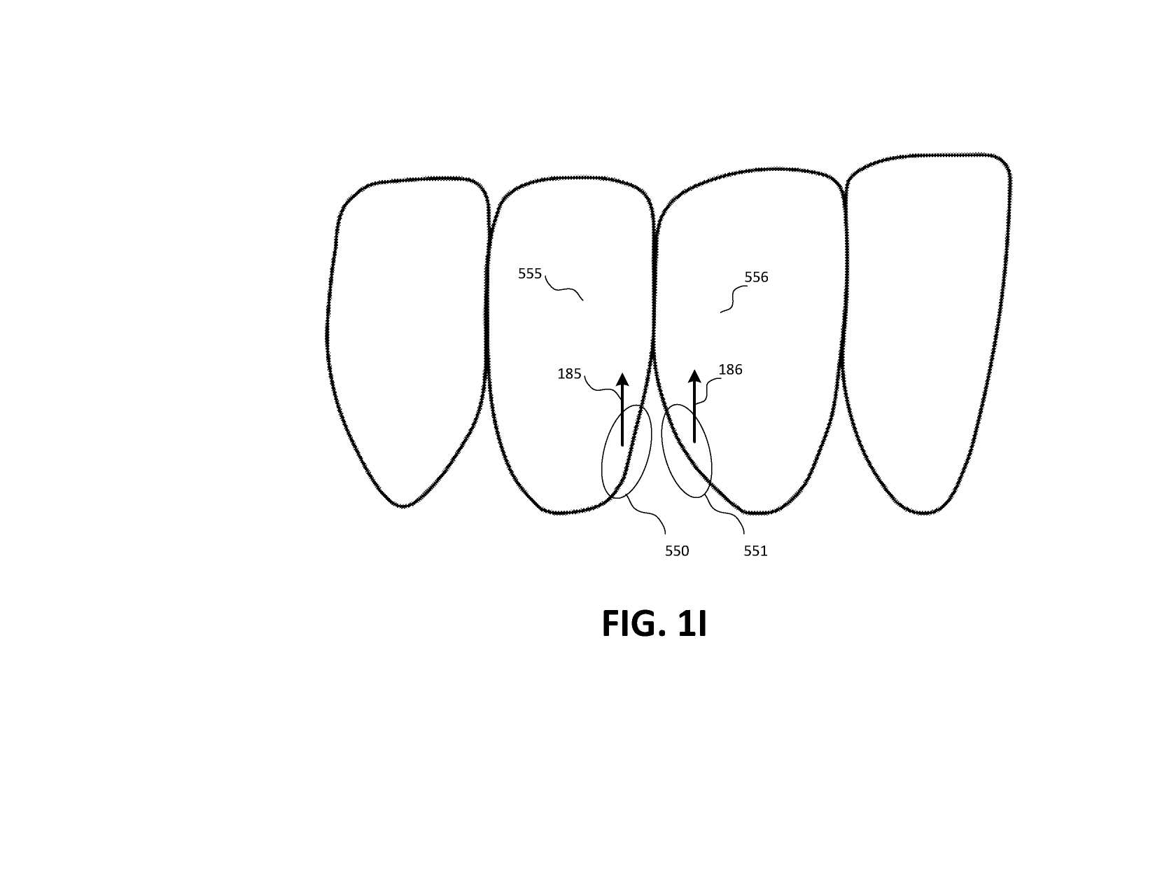

One approach is the delivery of medicaments through the gingival crevice 550, which may include the space between the tooth 555 and the tissue of the gingiva 545. FIG. 1A shows a perspective view of a portion of an oral cavity illustrating a representative gingival crevice 550 adjacent to a tooth 555 under normal conditions. Although FIG. 1A highlights a single tooth and its associated gingival crevice for clarity, it should be recognized that the oral cavity typically includes multiple gingival crevices. Each gingival crevice extends between the tooth surface and the gingival margin, continuing down to the junctional epithelium. Depositing a medicament seed within this space allows the medicament to be released gradually and absorbed rapidly through the specialized epithelial layer of the gingival crevice 550. The anatomical layout and physiological environment of the gingival crevice 550 will be discussed in more detail with reference to FIGS. 1B-1E.

More specifically, the junctional epithelium within the gingival crevice 550 shows considerable promise as a target for medicament delivery. The junctional epithelium has a high permeability due to its unique cellular structure and close contact with the underlying connective tissues, which are rich in immune cells. Because of this anatomical arrangement, the junctional epithelium allows medicaments to be rapidly absorbed directly into systemic circulation. As a result, this route has the potential to be more effective compared to conventional delivery methods.

FIGS. 1B-1E show an exemplary anatomy of a gingival crevice in the gingiva for targeting deposition and enhanced retention of medicament in accordance with embodiments of the present disclosure. It is noted that the illustration of the gingival crevice anatomy in FIGS. 1B-1E is intended to facilitate understanding the target region for medicament delivery as well as the challenges that arise from targeting the gingival crevice and the junctional epithelium for medicament delivery.

As shown, FIGS. 1B-1E illustrate detailed representations of the gingival crevice 550 within the gingiva 545, adjacent to the tooth 555. FIG. 1B shows a sagittal view of a representation of the tooth 555 and gingiva 545 under normal conditions. FIG. 1C shows a caudal (top-down) view that illustrates the overall geometry and orientation of the gingival crevice 550 relative to the tooth 555 structure. In embodiments, the gingival crevice 550 may be characterized as a potential space, which may indicate that although the crevicular epithelium and junctional epithelium 557 are normally in contact with the tooth 555, a space can be created within the gingival crevice 550 by insertion. This region contains two critical epithelial structures which may include the crevicular epithelium lining the crevice surface, which exhibits moderate bioabsorbability for medicament uptake, and the junctional epithelium 557 located deeper within the gingival crevice 550. The junctional epithelium 557 demonstrates high permeability, potentially attributable to its specialized cellular architecture and proximity to connective tissues rich in immune cells, allowing medicaments to permeate and be absorbed into the patient’s system. In particular, the junctional epithelium 557 may include mucosa type tissue that may allow medicament deposited or released within the gingival crevice 550 to “seep through” the junctional epithelium 557 and to be absorbed into the patient’s system. This anatomical arrangement may facilitate rapid, efficient absorption of therapeutic agents into the systemic circulation, which may provide and advantageous path for targeted medicament delivery.

FIG. 1D shows a top view of the exemplary anatomy of the gingival crevice 550 in the gingiva for targeting deposition of medicament in accordance with embodiments of the present disclosure. In particular, FIG. 1D shows two adjacent teeth, 555 and 556, and illustrates the anatomical layout of their corresponding gingival crevices 550 and 551. In this FIG. 1D, tooth 555 is associated with gingival crevice 550, while tooth 556 corresponds to gingival crevice 551. FIG. 1D illustrates the spatial relationship between the two gingival crevices 550 and 551, providing a depiction of how the gingival tissues interface with the tooth structures. In addition, this top-down view not only illustrates the positioning of the teeth 555 and 556 but also highlights the distinct anatomical characteristics of each gingival crevice 550 and 551. As shown, the gingival crevices 555 and 556 may be located at the juncture where the gingival margin meets the tooth surface, defining a narrow space that can be leveraged for the targeted deposition of medicament seeds for absorption through the junctional epithelium.

The inventors have found that achieving effective medicament delivery through the junctional epithelium 557 requires more than simply introducing a medicament into the general vicinity of the gingival crevice 550. For example, merely applying a liquid or fluid formulation into the gingival crevice 550 may be insufficient for facilitating absorption through the junctional epithelium 557. This is partly because of the mucosal nature of the junctional epithelium itself, which means that effective permeation and subsequent systemic uptake may require a certain duration of contact time for the medicament to diffuse across this tissue barrier of the junctional epithelium 557. Fluids, lacking structure, may typically clear quickly from the gingival crevice 550 by natural processes like salivary flow and tissue movement, preventing sustained contact.

In addition, the physical nature of the gingival crevice 550 may present a challenge for fluid-based delivery. For example, the gingival crevice 550 is a potential space, which may mean that the opposing tissues (e.g., tooth surface and gingival epithelium) are normally in contact or close apposition. Creating and maintaining an actual space for medicament placement requires physical displacement or wedging of the tissues. A liquid may lack the physical structure to create the space. For example, a fluid cannot effectively wedge open the potential space upon application, or even prop the space open against the natural tendency of the tissues to return to contact.

In embodiments, the medicament seeds described in various embodiments of the present disclosure may be specifically configured to overcome these limitations. For example, the medicament seeds of embodiments may possess a sufficiently defined physical form (e.g., solid, semi-solid, semi-amorphous) having the structural integrity to interact mechanically with the gingival crevice 550’s environment. Upon insertion, the medicament seed (or the deposition device arm in some embodiments) may operate as a wedge, physically creating a space between the tooth and the gingival tissues for deposition of the medicament seed.

The physical presence of the medicament seed within the gingival crevice 550 may not only create the space but may also maintain it for a duration determined by the medicament seed’s properties (e.g., dissolution rate, etc.). By propping open the gingival crevice 550, the medicament seed may ensure sustained contact between the dissolving carrier, the released medicament, and the junctional epithelium 557. This may allow the medicament to effectively permeate the junctional epithelium 557 for absorption into the patient’s system.

FIG. 1E shows a perspective view of a portion of an oral cavity illustrating a representative gingival crevice 550 adjacent to a tooth 555 under an open condition. For example, FIG. 1E presents an illustrative, somewhat exaggerated representation of the gingival crevice 550 to emphasize the potential space that may be utilized for medicament delivery in accordance with embodiments of the present disclosure. This view represents a scenario where the gingiva 545 is retracted or pulled away from the tooth 555, revealing the space of the gingival crevice 550 between the surface of the tooth 555 and the adjacent epithelial tissues. This visualization is intended to help in understanding the target anatomical space for the deposition of medicament seeds in accordance with embodiments of the present disclosure.

As shown, the created space within the gingival crevice 550 exhibits a generally V-shaped configuration, narrowing towards its apical end. Within this space, distinct regions may be identified relative to the epithelial lining. The upper region of the gingival crevice 550 space may be proximate to the crevicular epithelium, while the lower region may extend deeper, adjacent to the junctional epithelium 557. The junctional epithelium 557, as previously noted, includes characteristics highly favorable for systemic absorption.

The depiction in FIG. 1E underscores the objective of targeted medicament delivery within the gingival crevice 550. In particular, embodiments of the present disclosure may aim to insert a medicament seed such that it is deposited, at least partially, within the lower region of the gingival crevice 550, in close proximity to the junctional epithelium 557. Positioning the medicament seed in this apical area may leverage the high permeability of the junctional epithelium 557. For example, as the medicament seed dissolves and releases its medicament payload, the medicament may be presented to the junctional epithelium 557 for absorption into the patient’s systemic circulation.

FIGS. 1F-1H shows various examples of medicament seed insertion into the gingival crevice in accordance with embodiments of the present disclosure. FIG. 1F shows an exemplary operational scenario following the insertion of a medicament seed 110 into the gingival crevice 550 adjacent to tooth 555. In this example, the medicament seed 110 may include a solid and dissolvable physical structure. As shown, the deposition of the medicament seed 110 into the gingival crevice 550 may physically displace the gingival tissue of the gingiva 545 away from the tooth 555 surface, creating an actual space within the potential gingival crevice 550 in which the medicament seed 110 may reside. The creation and maintenance of the space may be due to the medicament seed 110’s solid form, which may enable it to resist the natural tendency of the gingival tissue to remain in close apposition to the tooth 555.

As also shown, the gingival tissue of the gingiva 545 may inherently seek proximity to the tooth 555, and may conform or wrap around the contours of the solid medicament seed 110. In embodiments, this may result in the upper region of the gingival crevice 550 remaining substantially closed or in contact with the tooth 555, while the medicament seed 110 may occupy the space more significantly in the lower region, particularly proximate to the junctional epithelium 557.

In embodiments, the tendency of the gingival tissue of the gingiva 545 to press against the inserted medicament seed 110 may generates inherent pressure within the gingival crevice 550. This pressure, larger in the deeper V-shaped portion near the junctional epithelium 557, may contribute to forces that may tend to displace or expulse the medicament seed 110 from the crevice 550. It is noted that retention mechanisms to counteract this displacement effect are discussed herein. Notwithstanding this displacement tendency, the placement shown in FIG. 1F positions the dissolvable medicament seed 110 ideally for medicament release. For example, as the medicament seed 110 dissolves over time, the medicament seed 110 may release the medicament directly into the maintained space adjacent to the highly permeable junctional epithelium 557, which may lead to absorption into the patient’s system through the junctional epithelium.

FIG. 1G illustrates another embodiment of the medicament seed 110 positioned within the gingival crevice 550 adjacent to tooth 555. In this example, the medicament seed 110 may be configured with semi-amorphous properties, such as resembling a gel, paste, or other formulation that may not be fully solid nor fully fluid. In this example, the composition of the medicament seed 110 may provide sufficient structural integrity to physically create and maintain a space within the gingival crevice 550 upon deposition.

In embodiments, the semi-amorphous medicament seed 110 shown in FIG. 1G may be able to conform, at least partially, to the contours of the gingival crevice 550. For example, the medicament seed 110 may have enough structure to wedge the potential space open, but flexible enough to adapt to the anatomical geometry of the gingival crevice 550, which may enable the medicament seed 110 to potentially increase the surface area of contact between the medicament seed 110 and the surrounding gingival tissues of the gingiva 545, including the junctional epithelium 557.

In embodiments, despite its ability to conform, the semi-amorphous medicament seed 110 may effectively maintain the space within the gingival crevice 550 to ensure that the released medicament remains localized near the target absorption site. For example, as the medicament seed 110 dissolves or degrades within the gingival crevice 550, the medicament payload of the medicament seed 110 may be released proximate to the junctional epithelium 557 to be absorbed into the patient’s system through the junctional epithelium 557.

FIG. 1H illustrates another embodiment of a medicament seed 105 positioned within the gingival crevice 550 adjacent to tooth 555 using a deposition device 100. In this embodiment, the medicament seed 105 may be formulated as a coating applied to at least a portion of the deposition device 100. In this example, the deposition device 100 carrying the medicament seed coating 105 may be inserted into the gingival crevice 550. The insertion of the device 100 may operate to create a space within the gingival crevice 550between the gingiva 545 and the tooth 555.

Once the deposition device 100 is positioned within the gingival crevice 550, such as at the base or deepest portion of the gingival crevice 550, particularly near the desired target region such as the junctional epithelium 557, the medicament seed 105, which may be a coating, may be transferred from the deposition device 100 into the space of the gingival crevice 550. In embodiments, the transfer may be facilitated by some actions, such as agitating the deposition device 100, moving the deposition device 100 back and forth within the gingival crevice 550, or employing another mechanism configured to release or dislodge the coating (e.g., the medicament seed 105) from the surface of the deposition device 100. FIG. 1H shows both the deposition device 100 within the crevice and the released medicament seed 105 residing therein post-transfer.

In embodiments, following the release of the medicament seed 105 from the deposition device 100, the medicament seed 105, now present as deposited material within the gingival crevice 550, may dissolve and release the embedded or carried medicament into the gingival crevice 550 for absorption through the junctional epithelium 557 and into the patient’s system.

As mentioned above, a primary objective for effective therapy is ensuring the medicament seed remains within the gingival crevice for a sufficient duration to permit dissolution and release of its medicament payload, allowing absorption through the junctional epithelium. However, achieving adequate retention within the gingival crevice presents significant challenges inherent to the anatomical configuration of the gingival crevice. For example, the anatomical configuration of the gingival crevice 550, particularly its V-shape which narrows towards the apical region adjacent to the junctional epithelium 557, naturally predisposes any deposited object, such as a medicament seed, to displacement forces directed upwards toward the broader opening of the gingival crevice. This tendency towards displacement may be further compounded by the dynamic oral environment, including the continuous flow of saliva and gingival crevice fluid, and movements of adjacent tissues, which may contribute to the premature migration of the medicament seed out of the gingival crevice 550 before it has fully dissolved and released its therapeutic payload.

FIG. 1I illustrates a front view of the gingival crevice anatomy of a patient that may be targeted for medicament deposition. In particular, FIG. 1I shows a front view of teeth 555 and 556 along with their respective gingival crevices 550 and 551, illustrating their spatial relationship and the target area for medicament delivery. FIG. 1I illustrates the alignment of the teeth 555 and 556and the adjacent gingival tissues, showing the positioning of the gingival crevices 550 and 551 where medicament seeds are targeted for deposition. The front view shows the relative placement of the gingival crevices 550 and 551 with respect to one another, providing an overall context of the oral anatomical environment and showing specific areas that may serve as targets for localized medicament delivery in accordance with embodiments of the present disclosure. It is noted that, a medicament seed deposited into one or more of the gingival crevices 550 and 551 may have a natural tendency to be displaced upwards toward the broader, upper region of the gingival crevice. For example, a medicament seed deposited into the gingival crevice 550 may have a natural tendency to be displaced upwards in direction 185 and a medicament seed deposited into the gingival crevice 551 may have a natural tendency to be displaced upwards in direction 186, which may cause the medicament seeds to migrate out of the respective gingival crevice before the medicament may be released.

In embodiments, the medicament seed may be configured for enhanced retention within the gingival crevice. In these embodiments, the medicament seed may operate as a carrier for therapeutic agents, such as micronutrient supplements, medicines, vaccines, drugs, etc., which may be intended for controlled release directly into the gingival crevice. By depositing the medicament seed into the targeted gingival crevice, the medicament seed may release its medicament payload gradually, ensuring that the therapeutic agent is efficiently absorbed through the permeable tissues of the crevicular and junctional epithelia.

In some embodiments, the medicament seed may be configured to provide a sustained and controllable release of the medicament. This controlled release mechanism may facilitate optimal bioavailability, as it may allow for the medicament to be absorbed over a predetermined period, reducing the need for frequent re-administration and enhancing the overall therapeutic efficacy. By focusing on the gingival crevice as the site of delivery (and in some embodiments in particular on the junctional epithelium), the disclosed system bypasses the challenges associated with other routes, such as degradation in the gastrointestinal tract, ensuring that a higher concentration of the active substance in the medicament reaches systemic circulation.

The medicament seed may be configured to carry and deliver medicaments to the gingival crevice of the patient. For example, the medicament seed may be configured to, upon deposition into the gingival crevice of the patient, release medicament in a controlled manner, ensuring that the medicament is absorbed into the patient’s system through the gingival crevice efficiently and effectively.

In embodiments, the medicament seed may have a semi-elastic or solid structure. This semi-elastic or solid structure may provide stability to the medicament seed during handling and insertion, while allowing for controlled dissolution once placed in the gingival crevice environment. In embodiments, a semi-elastic nature of the medicament seed may allow for some deformation during insertion, which may facilitate easier placement into the gingival crevice. In some embodiments, a solid structure may provide a more defined shape and controlled release profile.

In embodiments, the medicament seed may be composed of various materials, including polymers. The polymers may be selected based on their biocompatibility, dissolution properties, ability to carry and release the desired medicament, etc. In some embodiments, the medicament seed may be made from biodegradable polymers that break down naturally in the body over time. Examples of such polymers may include polylactic acid (PLA), polyglycolic acid (PGA), or copolymers of these materials.

In some embodiments, the medicament seed may be composed of hydrophilic polymers that absorb moisture from the gingival crevice environment, which may lead to swelling and eventual dissolution of the medicament seed. This particular property may allow for a gradual release of the medicament as the polymer matrix breaks down. In other embodiments, the medicament seed may be made from hydrophobic polymers that dissolve more slowly, which may provide a longer-lasting release of the medicament.

In embodiments, the size of the medicament seed may be configured to facilitate effective delivery and placement within the gingival crevice, while avoiding discomfort to the patient. In particular embodiments, the medicament seed may have a size ranging from 50 to 2000 microns (e.g., in diameter, length, width, and/or height). In some particular embodiments, such as where the medicament seed has an elongated shape, such as oblong, rectangular, or cylindrical configurations, the length of the medicament seed may range from 1 to 20 mm. These dimensions may enable optimal positioning of the medicament seed within the gingival crevice while providing sufficient volume for carrying an effective amount of medicament. The specific size and shape of the medicament seed may be selected based on factors such as the target treatment area, the type and amount of medicament to be delivered, the individual patient’s gingival crevice anatomy.

In some embodiments, the medicament seed may be multi-modal. For example, the medicament seed may be composed or made up of several smaller sub-seeds. In embodiments, each of the sub-seeds may be configured to carry different types or amounts of medicament. In some embodiments, the sub-seeds within the multi-modal medicament seed may vary in size, shape, and/or composition. In some embodiments, each sub-seed may be configured to dissolve at a different rate, allowing for a multi-stage release of medicaments over time. For example, one sub-seed may be formulated to dissolve rapidly, providing an initial burst of medication, while others may be designed for slower, sustained release.

In some embodiments, the multi-modal medicament seed may include sub-seeds with different physical properties. For example, some sub-seeds may be hydrophilic, readily absorbing moisture and dissolving quickly, while others may be hydrophobic, dissolving more slowly. In some embodiments, the sub-seeds may be arranged in layers, with each layer designed to dissolve sequentially. In other embodiments, the sub-seeds may be distributed randomly throughout the medicament seed, which may provide a more uniform release of different medicaments over time. It is noted that a medicament seed with a multi-modal structure may enable allow the incorporation of incompatible medicaments within a single medicament seed. By encapsulating different medicaments in separate sub-seeds, it may be possible to deliver combinations of medicaments that may otherwise be chemically incompatible if mixed directly.

In some embodiments, the multi-modal medicament seed may include sub-seeds with different functions. For example, some sub-seeds may be configured to enhance adhesion to the gingival crevice, while others may be formulated to modify the local environment to improve the efficacy of the delivered medicaments.

In some embodiments, the medicament seed may be coated with a palatable substance to enhance patient comfort and acceptance. This coating may mask any unpleasant taste or texture of the medicament, potentially improving patient compliance with the treatment. In embodiments the palatable coating may be designed to dissolve quickly in the oral environment, allowing the medicament seed to begin its therapeutic action promptly after deposition in the gingival crevice.

In embodiments, the medicament seed may be configured to contain, include, encapsulate, or otherwise carry the medicaments to be delivered to the patient. In embodiments, the medicament seed may be configured to begin its function of medicament delivery upon deposition into the gingival crevice. This release of the medicament into the gingival crevice by the dissolution of the medicament seed may range from immediate release to a sustained release spanning seconds, minutes, hours, or even days.

In embodiments, the medicament seed may be configured to contain medicament in encapsulated polymer (e.g., entrapped in nanoparticle spheres), which include nanoparticle spheres encapsulating or entrapping medicament therein. In some embodiments, free form medicament (e.g., unencapsulated within nanoparticle spheres) may be concurrently contained in the solvent containing nanoparticles.

In some embodiments, the medicament seed may be loaded with micronutrients that include, but are not limited to, vitamins such as retinoid and carotene (Vitamin A), B-complex vitamins like thiamin (Vitamin B1), riboflavin (Vitamin B2), niacin (Vitamin B3), pantothenic acid (Vitamin B5), pyridoxine (Vitamin B6), cobalamin (Vitamin B12), biotin, and folic acid (Vitamin B9), ascorbic acid (Vitamin C), vitamins D (including calciferol, calcifediol, cholecalciferol, and ergocalciferol) and E (alpha-tocopherol), and Vitamin K, including phylloquinone and menadione. The micronutrients may include essential minerals such as calcium, chloride, chromium, copper, fluoride, iodine, iron, magnesium, manganese, molybdenum, phosphorus, potassium, selenium, sodium, sulfur, and zinc, and/or antibiotics such as amikacin, betamethasone, clindamycin, clotrimazole, gentamicin, kanamycin, minocycline, oxytetracycline, penicillin, and tetracycline.

In some embodiments, the medicament seed may include anti-inflammatory agents, antimicrobials, antifungals, and antibodies to combat various pathogens. Steroids can be included for their potent anti-inflammatory effects, while antiparasitic, anti-amoebic, anti-helminthic, anti-protozoal, antinematode, anti-cestode, and anti-trematode agents can be used to treat specific parasitic infections.

In some embodiments, the medicament seed may include vaccine/s to combat various pathogens. In this manner, the medicament seed of embodiments may be used for immunomodulation to combat future infections (such as, without limitation, influenza, human papilloma virus, coronavirus, etc.) by enabling the delivery of controlled doses of the vaccine/s directly to the gingival crevice specifically targeting the junctional epithelium.

In embodiments, the medicament seed may include allergy-inducing antigens, specific allergy-inducing molecules, or any combination thereof, to act as allergenic tolerance therapies, or to act as vaccines. In this manner, the medicament seed of embodiments may be used to treat and modulate tolerance to food allergies, such as peanut or shellfish allergies, as well as vaccinate individuals, by enabling the delivery of controlled doses of the allergens directly to the gingival crevice.

In embodiments, the medicament seed may be dissolvable. In this manner, the medicament seed may be configured to degrade to molecular form over a period of time after being deposited into the gingival crevice. In some embodiments, the dissolution of the medicament seed may allow for controlled release of the medicament into the surrounding tissue. The rate of dissolution of the medicament seed may vary depending on factors such as the composition and structure of the medicament seed, the environmental conditions in the gingival crevice, the specific medicament being delivered, etc. In some embodiments, the medicament seed may be designed to dissolve completely, leaving no residue in the gingival crevice after the medicament has been fully released.

In some other embodiments, the medicament seed may be non-dissolvable and may remain within the gingival crevice after delivering the medicament. In these embodiments, the medicament seed may be configured to release the medicament over time while maintaining structural integrity. After the medicament has been fully delivered, the non-dissolvable medicament seed may need to be removed from the gingival crevice. This removal process may include a separate procedure or the use of specialized tools to extract the medicament seed from the gingival crevice.

In embodiments, the medicament seed may be composed, in whole or in part, of a dissolvable polymer that is selected for its biocompatibility and dissolution characteristics. A variety of polymers can be utilized for this purpose, including but not limited to hydroxy acids, lactic acid polymers, glycolic acid polymers, poly (hydroxyl acids), poly(lactic acid) (PLA), poly(glycolic acid) (PGA), poly(lactic-co-glycolic acid) (PLGA), and copolymers with PEG, polyanhydrides, poly(ortho) esters, polyesters, polyurethanes, poly(butyric acid), poly(valeric acid), poly(caprolactone), poly (hydroxyalkanoates), poly(lactide-co-caprolactone), blends and copolymers thereof, natural polymers, proteins, albumin, collagen, gelatin, prolamines, zein, polysaccharides, alginate, cellulose derivatives and polyhydroxyalkanoates, polyhydroxy butyrate blends, and copolymers thereof.

In additional or alternative embodiments, natural polymers such as proteins, albumin, collagen, gelatin, prolamines, zein, and polysaccharides like alginate, as well as cellulose derivatives and polyhydroxyalkanoates, polyhydroxy butyrate blends, and copolymers thereof and other biologics, can be employed to form the medicament seed.

In embodiments, the polymers used in the construction of the medicament seed may be processed using solvents such as dichloromethane, ethyl acetate, acetone, or a combination thereof, to achieve the desired form and dissolution rate. As such, the medicament seed’s configuration incorporates a dissolvable polymer matrix that responds to the environment of the gingival crevice providing functionality of the medicament seed to deliver medicaments over a controllable period of time. This configuration ensures that the medicament is released at a predetermined rate, providing a consistent and targeted therapeutic effect directly within the gingival crevice.

In embodiments, the rate of dissolution of the medicament seed may be configured to specific therapeutic requirements by adjusting the composition and properties of the medicament seed. For example, the rate of dissolution of the medicament seed may be configured by varying the type of polymer used for constructing the medicament seed, the concentration of the polymer (e.g., the density) of the medicament seed, the molecular weight of the polymer used for the medicament seed, the chain functional groups contents in the medicament seed, etc. In embodiments, the rate of dissolution may be increased or decreased by varying the above features. In some embodiments, the medicament seed may be configured with a multi-layered structure, where each layer has different dissolution properties, which may allow for phasic release of the medicament.

In embodiments, the rate of dissolution of the medicament seed may be configured based on the characteristics of the medicament seed, which may include the composition, structure, and/or surface energy of the polymer used in its construction. For example, for a slow and steady release of the medicament, the polymer may be selected or treated to dissolve at a slower rate, which may slow down the rate of dissolution in the moist environment of the gingival crevice. Conversely, for a more rapid release, the polymer may be treated or composed to dissolve at a faster rate subsequently increasing the rate of release of the medicament.

In embodiments, the medicament seed may be configured to carry the medicament using surface coating, in which at least a portion of the surface of the medicament seed may be coated with the medicament. In some embodiments, the medicament may be uniformly coated across the at least a portion of the surface of the medicament seed. In some embodiments, multiple coatings may be deposited over the surface of the medicament seed.

In embodiments, prior to coating with the medicament, a precoat layer may be applied to the medicament seed to modify the surface energy of the medicament seed, which may influence the dissolution rate and the subsequent release of the medicament. The precoat layer may also contain medicaments, which could be in free form, entrapped or encapsulated in particles (e.g., nanoparticles), encapsulated, or a combination thereof.

In embodiments, the medicaments with which the medicament seed may be coated may include medicaments in free form, entrapped or encapsulated in particles (e.g., nano-particles, encapsulated, or a combination thereof. In embodiments, the encapsulant for the medicament is selected from one or more polymers of the group consisting of poly(hydroxy acids), poly(lactic acid), Poly(glycolic acid), poly(lactic acid-co-glycolic acid), poly(lactic-co-glycolic acid), derivatives of poly(lactic-co-glycolic acid), PEGylated poly(lactic-co-glycolic acid), poly(lactide), poly(glycolide), poly(lactide-co-glycolide), poly(anhydrides), PEGylated poly(anhydrides), poly(ortho esters), derivatives of poly(ortho esters), PEGylated poly(ortho esters), poly(caprolactones), derivatives of poly(caprolactone), PEGylated poly(caprolactones), polyamines, spermine, spermidine, polylysine, and derivatives thereof, PEGylated polylysine, polyamides, polycarbonates, poly(propylene fumarates), polyamides, polyphosphazenes, polyamino acids, polyethers, polyacetals, polylactides, polyhydroxyalkanoates, polyglycolides, polyketals, polyesteramides, poly(dioxanones), polyhydroxybutyrates, polyhydroxyvalyrates, polycarbonates, polyorthocarbonates, poly(vinyl pyrrolidone), polycyanoacrylates, polyalkylene oxalates, polyalkylene succinates, poly(malic acid), poly(methyl vinyl ether), poly(ethylene imine), poly(acrylic acid), poly (maleic anhydride), poly(ethylene imine), derivatives of poly(ethylene imine), PEGylated poly(ethylene imine), poly (acrylic acid), derivatives of poly(acrylic acid), PEGylated poly(acrylic acid), poly(urethane), PEGylated polyurethane), derivatives of poly(urethane), poly (lactide), poly (glycolide), poly (hydroxyacids), polyesters, poly(arylates), polyalkylenes, polyethylene, polypropylene, polyalkylene glycols, poly(ethyleneglycol), polyalkylene oxides such as poly(ethylene oxide), polyalkylene terepthalates, poly(ethylene terephthalate), polyvinyl alcohols, polyvinyl ethers, polyvinyl esters, polyvinyl halides such as poly(vinyl chloride), polyvinylpyrrolidone, polysiloxanes, poly(vinyl alcohols), poly(vinylacetate), polystyrene, polyurethanes and co-polymers thereof derivatized celluloses, alkyl cellulose, hydroxyalkyl celluloses, cellulose ethers, cellulose esters, nitro celluloses, methyl cellulose, ethyl cellulose, hydroxypropyl cellulose, hydroxy-propyl methyl cellulose, hydroxybutylmethyl cellulose, cellulose acetate, cellulose propionate, cellulose acetate butyrate, cellulose acetate phthalate, carboxylethyl cellulose, cellulose triacetate, cellulose sulfate sodium salt, polymers of acrylic acid, methacrylic acid or copolymers or derivatives thereof, methacrylic acid esters, poly(methyl methacrylate), poly(ethyl methacrylate), poly(butylmethacrylate), polyisobutyl methacrylate), poly(hexylmethacrylate), poly(isodecyl methacrylate), poly(laurylmethacrylate), poly(phenyl methacrylate), poly(methylacrylate), poly(isopropyl acrylate), poly(isobutyl acrylate), and poly(octadecyl acrylate), poly(butyric acid), poly(valeric acid) , and poly(lactide-co caprolactone ) and/or derivatives thereof, acrylic acid and methacrylic acid copolymers, methyl methacrylate copolymers, ethoxyethyl methacrylates, cyanoethyl methacrylate, aminoalkyl methacrylate copolymer, poly(acrylic acid), poly(methacrylic acid), methacrylic acid alkylamide copolymer, poly(methyl methacrylate), poly(methacrylic acid anhydride), methyl methacrylate, polymethacrylate, poly(methylmethacrylate) copolymer, polyacrylamide, aminoalkyl methacrylate copolymer, glycidyl methacrylate copolymers, polycyanoacrylates, and/or combinations thereof, natural polymers, proteins (such as albumin, collagen, gelatin), prolamines (for example, zein), polysaccharides (such as alginate), cellulose derivatives (such as hydroxypropyl cellulose, sodium carboxymethyl cellulose, ethyl cellulose and cellulose acetate), polyhydroxyalkanoates (for example, poly(hydroxybutyrate), and/or combinations thereof.

In embodiments, the medicament seed may be configured to carry the medicament using a polymer/medicament mixture, which may include integrating the medicament directly into the polymer matrix to form a polymer/medicament mixture. The polymer/medicament mixture may be used to form or make the medicament seed. In this manner, the medicament is not merely coated on the surface of the medicament seed but is distributed throughout the polymer material, making it an intrinsic part of the medicament seed’s composition.

In embodiments, the polymer used for the polymer/medicament mixture may be a biocompatible, biodegradable polymer that is well-tolerated within the oral environment. The selection of the polymer may be based on its dissolution properties, compatibility with the medicament, and the desired release profile. Polymers such as poly(lactic acid), poly(glycolic acid), and their copolymers, including poly(lactic-co-glycolic acid), may be used due to their ability to degrade into non-toxic byproducts.

In embodiments, the medicament seed may be configured to carry the medicament using an internal well. For example, in embodiments, an internal well may be formed within the interior of the medicament seed. The internal well may be configured to encapsulate or trap the medicament within, which may be in liquid form or another suitable state for controlled release. The medicament seed may be configured to degrade or dissolve at a predetermined rate once placed within the moist environment of the gingival crevice. As the medicament seed begins to dissolve, it eventually breaches the internal well, allowing the encapsulated medicament to escape and be released into the gingival crevice. This release mechanism is activated by the dissolution of the medicament seed, which may be calibrated to occur over a controllable period.

In embodiments, the medicament seed 150 may be configured to carry the medicament using internal thread-like structures (monofilament) or mesh. In some embodiments, each thread of the internal thread-like structure may carry a different medicament portion and/or a different type of medicament. In some embodiments, these thread-like structures may be incorporated into a housing configured to dissolve. In embodiments, the housing and the internal thread-like structures may form a medicament seed.

In some embodiments, the internal well of the medicament seed may be configured to hold multiple types of medicaments, allowing for a combination therapy approach. For example, in some embodiments, the internal well may include multiple sub-wells, each sub-well configured to encapsulate and/or trap a different type and/or dosage of medicament. In some embodiments, each of the sub-wells may be configured to breach at different dissolution times of the medicament seed, which may allow for a multi-stage delivery of the medicament dosages. In some embodiments, the multiple sub-wells may be laid out side-by-side, or may be laid out one within the other (e.g., a first sub-well may be encapsulated by a second sub-well, etc.).

In embodiments, the medicament seed may be configured to carry the medicament using a multi-stage delivery configuration. The multi-stage delivery configuration may represent a combination of the features of the polymer/medicament mixture configuration and the internal well configuration. In the multi-stage delivery configuration, the medicament seed may be composed of a polymer/medicament mixture, and additionally, an internal well may be incorporated to encapsulate additional medicament. This configuration allows for a sequential release of medicaments. For example, in a first stage of the multi-stage delivery configuration of the medicament seed, as the medicament seed begins to dissolve within the gingival crevice, the medicament embedded within the polymer/medicament mixture may be gradually released. A second stage of the multi-stage delivery configuration may be initiated once the dissolution process reaches the internal well of the medicament seed, breaching its integrity and allowing the encapsulated medicament to be released into the gingival crevice. This second stage can be configured to occur after a predetermined time interval following the initial release, providing a subsequent boost or a different therapeutic action as dictated by the treatment plan. The encapsulated medicament within the internal well may include the same type of medicament as in the polymer/medicament mixture for a sustained dosage or may include a different type of medicament to address additional aspects of the patient’s condition.

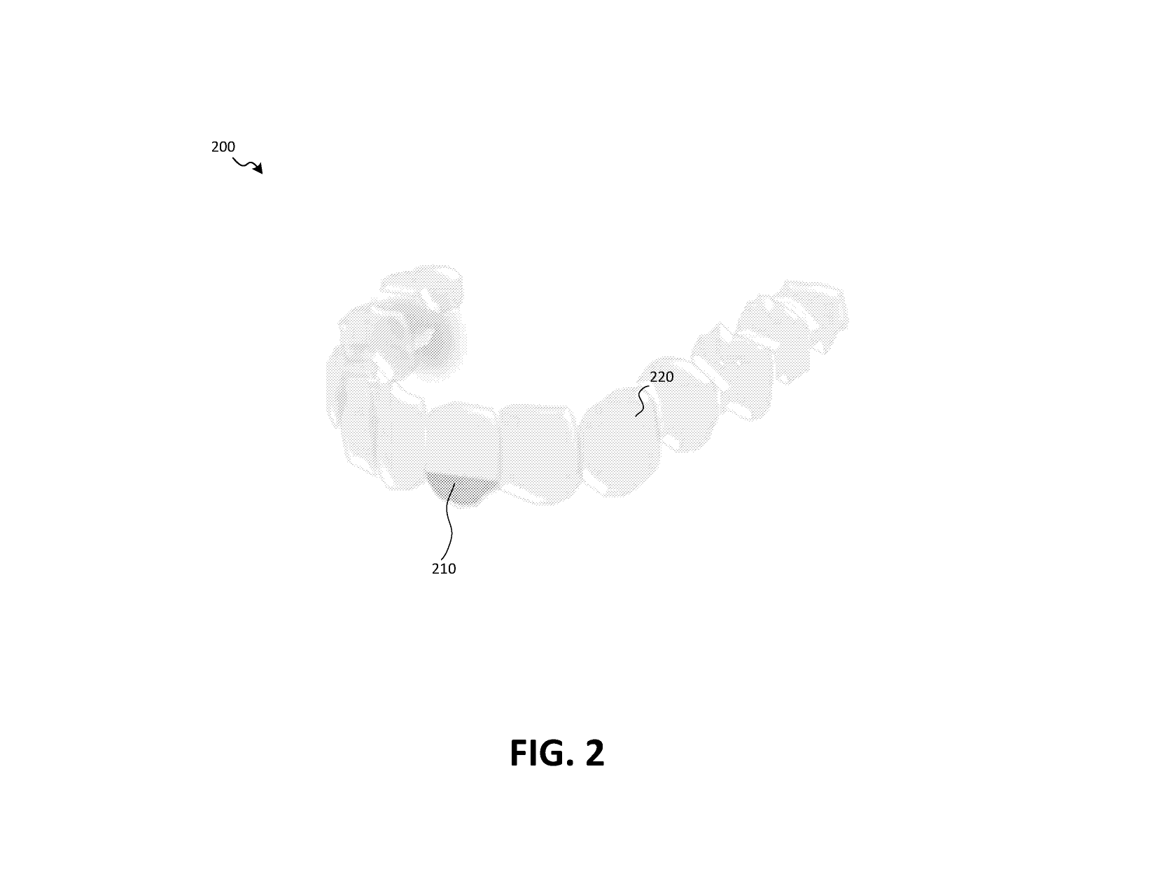

It is noted that any of the above described features and/or characteristics of the medicament seed may be used for any of the configurations of the medicament seeds or medicaments described with respect to FIGS. 2-13. In this manner, the medicament described herein may be provided, physically, functionally, and/or conceptually, as a medicament seed.

It is noted that the present disclosure, and the various features and advantageous details thereof, are explained more fully with reference to the non-limiting examples illustrated in the accompanying drawings and detailed in the description below. The examples used in the following description are intended to facilitate an understanding of the ways in which the present disclosure may be implemented and practiced. A person of ordinary skill in the art would understand from this disclosure that any suitable combination of the functionality and exemplary embodiments described herein may be used to carry out the subject matter claimed. The present disclosure may include representative species falling within the scope of the disclosed genus, as well as structural features common to members of that genus, such that one of ordinary skill in the art may recognize additional members and variants that fall within the scope of the present disclosure. Accordingly, these examples should not be construed as limiting the scope of the present disclosure and/or claims.

A person of ordinary skill in the art would further understand that the disclosed systems, devices, and methods may be implemented in a variety of forms without departing from the spirit of the present disclosure. In embodiments, individual features described in connection with one embodiment may be used in combination with features of another embodiment, even where such combinations are not expressly illustrated. In embodiments, structural features, medicament-loading features, targeting features, cartridge features, and operational features described herein may be combined, substituted, omitted, rearranged, or otherwise modified depending on the particular application, treatment objective, anatomical target, material selection, or manufacturing technique. Accordingly, the following detailed description is intended to be illustrative rather than restrictive, and the scope of the present disclosure should be determined with reference to the appended claims and their equivalents rather than with reference to the particular examples described herein.

Various embodiments of the present disclosure are directed to devices, systems, and techniques for orthodontic devices for delivery of medicament to the junctional epithelium of the gingival crevice. In embodiments, medicament (e.g., medicament and/or medicament seed) may be loaded onto an orthodontic device configured to deliver the medicament to the junctional epithelium of the gingival crevice.

In embodiments, the disclosed devices may be configured to facilitate the accurate positioning of medicament relative to a target gingival crevice by relying on structures that conform to the dental anatomy of a patient. In this manner, the disclosed devices may reduce the difficulty associated with manually locating and accessing a particular gingival crevice, and may improve the consistency with which medicament may be delivered to a desired site within the oral cavity. In embodiments, the disclosed devices may be configured to improve one or more of targeting accuracy, medicament localization, medicament retention, medicament release, ease of administration, patient compliance, and repeatability of treatment. The disclosed structures may include, without limitation, customized orthodontic retainers, customized caps configured for individual teeth, targeting retainers having targeting holes, medicament delivery cartridges, cartridge systems having reusable handles and actuators, and methods of using the same

In embodiments, the disclosed orthodontic devices may be configured in at least two non-limiting implementations. For example, in embodiments, a customized orthodontic device may be configured to directly carry medicament, such that when the customized orthodontic device is positioned on the teeth of a patient, the medicament may be brought into proximity with, inserted into, or otherwise delivered to a target gingival crevice. In additional or alternative embodiments, a customized orthodontic device may be configured to operate as a targeting structure that may include one or more targeting openings through which a separate medicament delivery cartridge may be guided to a selected gingival crevice. In either configuration or implementation, the disclosed devices may be configured to take advantage of the patient-specific fit of an orthodontic structure so that the medicament, or the medicament delivery path, may be positioned relative to a desired gingival crevice in a more controlled and predictable manner than may be achievable through freehand placement alone.

As discussed above, the gingival crevice may define a narrow anatomical space adjacent to a tooth and extending toward the junctional epithelium, which may be located at the apical aspect of the gingival crevice. In embodiments, the junctional epithelium may be a particularly advantageous target for medicament delivery because of its permeability and its anatomical relationship to underlying tissues. However, the anatomy of the gingival crevice may also make delivery difficult. For example, the gingival crevice may be relatively small, patient anatomy may vary, and the process of manually inserting medicament into the gingival crevice to reach the junctional epithelium may be prone to error. In embodiments, by using customized orthodontic devices configured to conform to the patient’s dentition, the disclosed systems may provide a structural reference that may guide medicament delivery to one or more selected gingival crevices to target the junctional epithelium. The examples described herein illustrate representative embodiments in which customized orthodontic devices may be configured to directly carry medicament, to deposit medicament within a gingival crevice, to release medicament from a reservoir structure, and/or to guide a separate cartridge for targeted delivery into a selected gingival crevice, among other functionalities.

FIG. 2 shows a diagram illustrating an example of a customized orthodontic device 200 configured for medicament delivery to a gingival crevice of a patient in accordance with embodiments of the present disclosure. In embodiments, the device 200 shown in FIG. 2 may include a retainer 220 that is configured to conform to at least a portion of the dentition of the patient, and a medicament 210 loaded onto at least a portion of the retainer 220. In embodiments, the retainer 220 may be configured as a custom-fitted orthodontic structure that is shaped based on the anatomy of the patient’s teeth and surrounding gingival region so that, when the retainer 220 is positioned over the teeth, the medicament 210 may be brought into a predetermined positional relationship relative to one or more target gingival crevices. In this manner, the retainer 220 may operate not merely as a support structure for carrying the medicament 210, but also as a positioning structure that may facilitate accurate and repeatable placement of the medicament 210 relative to the oral anatomy of the patient.

In embodiments, the retainer 220 may be configured as a full-arch retainer, aligner, mouthguard-style structure, shell, tray, or other orthodontic device configured to be removably positioned over one or more teeth of the patient. In embodiments, because the retainer 220 may be custom fitted, the retainer 220 may provide a consistent spatial reference for carrying the medicament 210 to a selected treatment location. For example, where the medicament 210 is loaded onto a selected portion of the retainer 220 corresponding to a target tooth or group of teeth, seating of the retainer 220 over the dentition may automatically bring the medicament 210 into alignment with the gingival crevice associated with that region. In embodiments, this configuration may reduce variability in medicament placement, may reduce reliance on manual freehand targeting by the user, and/or may improve the likelihood that the medicament 210 may be delivered into or immediately adjacent to a desired gingival crevice for subsequent absorption through the junctional epithelium

In embodiments, the orthodontic device 220 may be configured as a custom-fitted intraoral structure that is shaped to correspond to at least a portion of the dentition of a patient. For example, the orthodontic device 220 may be configured as a retainer, an aligner, a mouthguard, a cap, a tray, a shell, or another orthodontic or dental appliance configured to be removably positioned over one or more teeth. In embodiments, the orthodontic device 220 may extend over an entire dental arch, a portion of a dental arch, or only one or more selected teeth depending on the particular treatment configuration. In embodiments, the orthodontic device 220 may include one or more tooth-receiving contours, recesses, channels, pockets, cavities, or interior surfaces configured to conform to the external geometry of the teeth so that the orthodontic device 220 may be repeatedly seated in a predictable position within the oral cavity. By configuring the orthodontic device 220 in this manner, the orthodontic device 220 may provide a stable and repeatable structural platform for carrying the medicament 210 to a desired location relative to the gingival anatomy of the patient.

In embodiments, the orthodontic device 220 may be custom-manufactured using patient-specific anatomical information so that the orthodontic device 220 may conform to the particular geometry of the patient’s teeth and surrounding oral structures. For example, the orthodontic device 220 may be formed based on a physical impression, a cast, a mold, an intraoral scan, a digital three-dimensional model, or another representation of the patient’s dentition. In embodiments, the orthodontic device 220 may be thermoformed, molded, machined, additively manufactured, three-dimensionally printed, or otherwise fabricated using a suitable process. Because the orthodontic device 220 may be fitted to the particular patient, insertion of the orthodontic device 220 into the oral cavity may position the orthodontic device 220 in substantially the same manner each time it is worn. This repeatable seating characteristic may be advantageous because it may allow the medicament 210 associated with the orthodontic device 220 to also be repeatedly positioned at a desired location relative to a selected tooth, a selected gingival crevice, a selected interproximal region, or another treatment site.

In embodiments, the medicament 210 may define a medicament-bearing region of the orthodontic device 220, and the medicament 210 may be associated with the orthodontic device 220 in a variety of ways. For example, the medicament 210 may be integrated into the material of the orthodontic device 220, coupled to the orthodontic device 220, coated on the orthodontic device 220, contained within the orthodontic device 220, supported by the orthodontic device 220, or otherwise carried by or associated with the orthodontic device 220. In embodiments, the medicament 210 may be disposed on an interior-facing surface of the orthodontic device 220 such that the medicament 210 may face the teeth and/or gingival tissues when the orthodontic device 220 is seated. In embodiments, the medicament 210 may be positioned at only one selected region of the orthodontic device 220 corresponding to a target tooth or target gingival crevice. In additional or alternative embodiments, the medicament 210 may be distributed across multiple regions of the orthodontic device 220 so that multiple treatment sites may be addressed during the same use of the orthodontic device 220.

In embodiments, the medicament 210 may be provided in any suitable form that may allow the medicament 210 to be carried by the orthodontic device 220 and subsequently delivered within the oral cavity. For example, the medicament 210 may be provided as a coating, layer, film, deposit, patch, bead, strip, seed, gel, paste, matrix, dissolvable material, semi-solid material, viscous material, or other medicament-containing form. In embodiments, the medicament 210 may be carried on a surface of the orthodontic device 220, embedded within the body of the orthodontic device 220, disposed within one or more cavities or compartments of the orthodontic device 220, or otherwise positioned such that seating of the orthodontic device 220 may bring the medicament 210 into a desired positional relationship with the gingival crevice. In this manner, the orthodontic device 220 may operate as a dental appliance configured to fit the anatomy of the patient, and as a positioning and support structure configured to carry the medicament 210 and bring the medicament 210 to a target treatment location in a controlled and repeatable manner.

As noted, in embodiments, the medicament 210 may be associated with the orthodontic device 220 in a variety of configurations depending on the desired delivery profile, the structure of the orthodontic device 220, the target location within the oral cavity, and/or the characteristics of the medicament itself. For example, the medicament 210 may be incorporated into the body of the orthodontic device 220, may be loaded into one or more designated portions of the orthodontic device 220, may be disposed as a coating on one or more surfaces of the orthodontic device 220, or may otherwise be carried by the orthodontic device 220 in a manner such that seating of the orthodontic device 220 positions the medicament 210 relative to a target gingival crevice. In embodiments, the manner in which the medicament 210 is associated with the orthodontic device 220 may be selected based on whether the desired treatment calls for immediate release, delayed release, sustained release, localized release, multi-site release, and/or another release behavior.

In embodiments, the medicament 210 may be incorporated directly into the body material of the orthodontic device 220. For example, the medicament 210 may be dispersed, entrained, suspended, embedded, encapsulated, mixed, or otherwise integrated into a polymeric or other structural material from which the orthodontic device 220 is formed. In these embodiments, the orthodontic device 220 itself may operate as a medicament-carrying matrix, such that the medicament 210 may be released from the body of the orthodontic device 220 over time when the orthodontic device 220 is positioned within the oral cavity. In embodiments, the medicament 210 may be incorporated throughout substantially the entire body of the orthodontic device 220, or may instead be incorporated only within one or more defined regions of the orthodontic device 220.

In embodiments, the medicament 210 may be loaded into one or more designated portions of the orthodontic device 220 rather than being uniformly incorporated throughout the full structure. For example, the orthodontic device 220 may include one or more selected areas, zones, regions, pockets, recesses, cavities, channels, compartments, reservoirs, or other medicament-receiving portions into which the medicament 210 may be placed. In embodiments, these designated portions may be positioned such that, when the orthodontic device 220 is seated, the medicament 210 carried therein may align with a selected tooth, a selected interproximal region, a selected gingival crevice, or a selected portion of the gingival margin. In embodiments, loading the medicament 210 into one or more designated portions of the orthodontic device 220 may allow the medicament 210 to be concentrated at one or more targeted treatment sites without requiring medicament 210 to be present throughout the entirety of the orthodontic device 220. This configuration may reduce waste, may improve targeting precision, may allow different portions of the orthodontic device 220 to carry different medicaments 210, and/or may allow different portions of the orthodontic device 220 to carry different amounts of medicament 210.

In embodiments, the medicament 210 may be disposed as a coating on an interior-facing surface of the orthodontic device 220. For example, the medicament 210 may be applied to a surface of the orthodontic device 220 that faces the teeth, the gingival tissues, or both when the orthodontic device 220 is inserted into the oral cavity. In embodiments, the medicament 210 may be applied as a film, layer, coating, deposit, patch, strip, bead, gel coating, paste coating, or other surface-associated medicament form. In embodiments, the medicament 210 may adhere directly to the surface of the orthodontic device 220, may be retained by a binder or adhesive, may be carried by a dissolvable coating layer, and/or may otherwise be supported on the interior-facing surface of the orthodontic device 220. In these embodiments, seating of the orthodontic device 220 may bring the coated medicament 210 into direct contact with, or into close proximity to, the gingival crevice so that the medicament 210 may be transferred, dissolved, released, or otherwise made available for delivery at the desired location.

In embodiments, the medicament 210 may be positioned only in selected areas of the orthodontic device 220 corresponding to selected teeth or selected gingival crevices. For example, if treatment is desired at only one tooth, one side of one tooth, one interproximal area, or one gingival crevice, the medicament 210 may be positioned only at the corresponding region of the orthodontic device 220. In embodiments, this localized loading arrangement may allow the orthodontic device 220 to serve as a targeting structure that carries the medicament 210 only where needed, rather than over the full appliance. In embodiments, the medicament 210 may be positioned adjacent to one anterior tooth, one posterior tooth, multiple adjacent teeth, alternating teeth, or any selected subset of teeth depending on the intended treatment plan. In this manner, the orthodontic device 220 may be customized not only to the anatomy of the patient, but also to the specific site or sites selected for medicament delivery.

In additional or alternative embodiments, the medicament 210 may be distributed over larger portions of the orthodontic device 220 or throughout substantially the entire structure of the orthodontic device 220. For example, the medicament 210 may be disposed across a substantial length of an interior-facing surface of the orthodontic device 220, across multiple tooth-corresponding regions, across an entire arch-spanning portion of the orthodontic device 220, or throughout the full body of the orthodontic device 220. In embodiments, this broader distribution of the medicament 210 may be useful where it is desired to expose multiple gingival crevices to the medicament 210 during a single use of the orthodontic device 220, and/or where a broader local or systemic delivery effect is desired. In embodiments, the orthodontic device 220 may carry the medicament 210 in a highly localized arrangement, a partially distributed arrangement, and/or a broadly distributed arrangement, with the particular configuration being selected based on the anatomy being targeted, the medicament 210 being delivered, and the desired therapeutic result.

In embodiments, when the orthodontic device 220 is seated on the teeth of the patient, the orthodontic device 220 may automatically position the medicament 210 at a predetermined location relative to a target gingival crevice. Because the orthodontic device 220 may be custom-fitted to the dental anatomy of the patient, insertion of the orthodontic device 220 may repeatedly place the medicament 210 in substantially the same positional relationship relative to one or more selected teeth and the gingival crevices associated therewith. In this manner, the orthodontic device 220 may operate as a positioning structure in addition to operating as a medicament-carrying structure. Rather than requiring a user to manually guide the medicament 210 to a precise gingival location through freehand placement alone, the orthodontic device 220 may use its fitted geometry to bring the medicament 210 into alignment with the target gingival crevice as a consequence of seating the orthodontic device 220 over the dentition.

In embodiments, this automatic positional alignment may improve targeting accuracy. For example, the gingival crevice may define a relatively small and anatomically specific target area, and the depth, position, and orientation of a given gingival crevice may vary from patient to patient and from tooth to tooth. In embodiments, the use of a custom-fitted orthodontic device 220 may reduce the difficulty associated with attempting to visually estimate or manually locate the proper delivery site during each administration event. By structurally encoding the target location into the fitted geometry of the orthodontic device 220, the disclosed configuration may provide a more controlled pathway for bringing the medicament 210 to the intended treatment region. In embodiments, this may be particularly advantageous where the desired target is not merely a general gingival area, but a specific gingival crevice associated with a selected tooth or selected interproximal region, and in embodiments where delivery proximate to the junctional epithelium is desired.

In embodiments, the orthodontic device 220 may also reduce user error. For example, in the absence of a fitted positioning structure, a user attempting to deliver medicament into a gingival crevice may miss the intended site, may deliver the medicament to the wrong tooth region, may fail to achieve sufficient depth or proximity relative to the gingival crevice, or may inconsistently place the medicament from one use to another. In embodiments, because the orthodontic device 220 may be configured to seat in a predefined manner on the teeth, the orthodontic device 220 may reduce the number of variables controlled by the user during application. The user may no longer need to rely exclusively on hand stability, visual estimation, or anatomical familiarity in order to place the medicament 210. Instead, proper seating of the orthodontic device 220 may itself guide the medicament 210 into the desired positional relationship with the target gingival crevice, which may reduce inconsistency and may make administration easier for both trained clinicians and non-clinician users.

In embodiments, the orthodontic device 220 may facilitate repeatable medicament placement across multiple treatment sessions. For example, because the orthodontic device 220 may be removably insertable and may be configured to fit the patient in a repeatable manner, the same orthodontic device 220 may be used to deliver medicament 210 to the same target region multiple times over a treatment course. This repeatability may be beneficial where a medicament regimen calls for repeated delivery to the same gingival crevice, repeated local treatment at the same site, or repeated systemic delivery through the same anatomical route. In embodiments, the repeatable placement characteristics of the orthodontic device 220 may improve dosing consistency, may improve predictability of treatment, and may provide a more reliable platform for targeted medicament delivery than approaches that depend solely on repeated freehand placement.

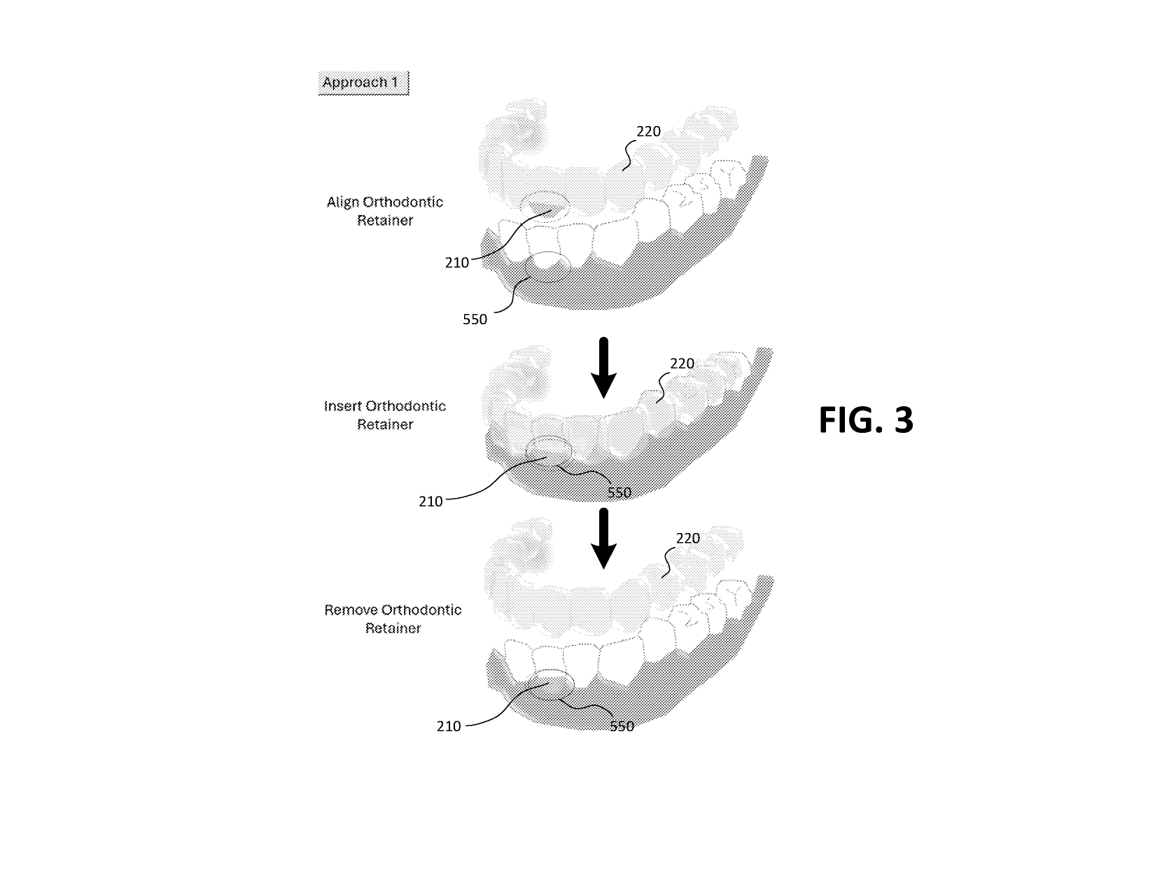

FIG. 3 shows a diagram illustrating an example operational sequence showing one approach for using the orthodontic device 220 to deliver medicament to a gingival crevice of a patient for absorption through a junctional epithelium in accordance with embodiments of the present disclosure. In embodiments, FIG. 3 may illustrate a sequence of use in which the orthodontic device 220 is first aligned relative to the dentition of the patient, then inserted or seated onto the teeth, and thereafter removed after the medicament 210 has been positioned at the desired treatment location. In this manner, FIG. 3 may be understood as illustrating not merely the structure of the orthodontic device 220 itself, but also a representative mode of operation by which the orthodontic device 220 may be used as a positioning and delivery structure for the medicament 210.

In embodiments, the operational sequence shown in FIG. 3 may include an alignment stage, an insertion or seating stage, and a removal stage. During the alignment stage, the orthodontic device 220 may be positioned above or otherwise relative to the teeth so that the medicament 210 carried by the orthodontic device 220 may be brought into registration with the target gingival crevice 550. During the insertion or seating stage, the orthodontic device 220 may be moved onto the teeth so that the orthodontic device 220 assumes its fitted position relative to the dental anatomy of the patient, bringing the medicament 210 into the intended positional relationship with the gingival crevice 550. During the removal stage, the orthodontic device 220 may be withdrawn from the teeth, while the medicament 210 may remain positioned within or adjacent to the gingival crevice 550, depending on the particular configuration of the medicament 210 and the particular manner in which the medicament 210 is associated with the orthodontic device 220.

In embodiments, the orthodontic device 220 shown in FIG. 3 may be configured as a full-arch orthodontic retainer extending over multiple teeth of the patient. For example, the orthodontic device 220 may be configured to span a plurality of adjacent teeth along a dental arch so that seating of the orthodontic device 220 may place the orthodontic device 220 in a stable and repeatable position relative to the oral anatomy. In embodiments, because the orthodontic device 220 may be configured as a full-arch orthodontic retainer, the orthodontic device 220 may derive positional stability from engagement with multiple teeth rather than from engagement with only a single tooth. This may improve the consistency with which the medicament 210 is delivered to the target gingival crevice 550 and may provide a stable delivery platform for medicament placement during use

In embodiments, during the alignment stage, the orthodontic retainer 220 may be positioned relative to the teeth of the patient and relative to the target gingival crevice 550 before the orthodontic retainer 220 is fully seated. As shown, the orthodontic retainer 220 may be held above the dentition in a manner such that the medicament 210 carried by the orthodontic retainer 220 is brought into alignment with the selected treatment location. In embodiments, the medicament 210 may define a medicament-bearing region of the orthodontic retainer 220, and during the alignment stage this medicament-bearing region may be visually and structurally registered relative to the tooth and the gingival crevice 550 associated with that tooth. In embodiments, this alignment stage may allow the user to position the orthodontic retainer 220 so that the medicament 210 is properly oriented before the orthodontic retainer 220 is moved fully into place.

In embodiments, the custom-fitted nature of the orthodontic retainer 220 may facilitate the alignment stage. For example, because the orthodontic retainer 220 may be shaped to conform to the anatomy of the patient’s teeth, the orthodontic retainer 220 may have a predetermined seating path and a predetermined seated position. As a result, once the orthodontic retainer 220 is brought into the proper general alignment with the teeth, the medicament 210 loaded onto the orthodontic retainer 220 may already be positioned relative to the selected tooth and the selected gingival crevice 550 in the manner intended by the design of the orthodontic retainer 220. In embodiments, this may reduce the need for fine freehand positioning of the medicament 210 itself. Instead, the user may align the orthodontic retainer 220 as a whole, and the fitted geometry of the orthodontic retainer 220 may correspondingly align the medicament 210 with the target gingival crevice 550.

In embodiments, during the insertion or seating stage, the orthodontic retainer 220 may be moved downwardly or otherwise advanced onto the teeth until the orthodontic retainer 220 becomes seated in its intended fitted position. As the orthodontic retainer 220 is seated over the teeth, the medicament 210 carried by the orthodontic retainer 220 may move into the gingival region adjacent the selected tooth. In embodiments, the seating of the orthodontic retainer 220 may bring the medicament 210 into, or into close proximity with, the gingival crevice 550. Depending on the particular configuration of the medicament 210 and the orthodontic retainer 220, insertion of the orthodontic retainer 220 may cause the medicament 210 to enter the gingival crevice 550, to face the gingival crevice 550, to engage tissue adjacent the gingival crevice 550, or otherwise to communicate with the gingival crevice 550 in a manner that facilitates medicament delivery.

In embodiments, the seated position of the orthodontic retainer 220 may be particularly advantageous because it may use the structural fit of the orthodontic retainer 220 against multiple teeth to stabilize the medicament 210 at the intended treatment location. For example, once the orthodontic retainer 220 is fully seated, the medicament 210 may be positioned with a repeatable depth, orientation, and lateral position relative to the gingival crevice 550. In embodiments, this may facilitate localized delivery to the gingival crevice 550 and, in embodiments, may facilitate delivery deeper toward the junctional epithelium. In embodiments, the medicament 210 may be carried in a form that allows it to be transferred, deposited, pressed into place, released, dissolved, or otherwise made available for therapeutic action as a result of seating the orthodontic retainer 220 onto the teeth.

In embodiments, during the removal stage, the orthodontic retainer 220 may be removed from the teeth after insertion and after the medicament 210 has been brought into the desired positional relationship with the gingival crevice 550. In embodiments, removal of the orthodontic retainer 220 may occur after a brief placement interval, after a longer treatment interval, or after another selected period depending on the formulation of the medicament 210 and the intended mode of delivery. As shown, after the orthodontic retainer 220 is removed, the medicament 210 may remain deposited within the gingival crevice 550. In embodiments, this may occur where the medicament 210 is configured to detach from the orthodontic retainer 220 during seating or during removal, thereby leaving at least a portion of the medicament 210 behind at the target site.

In embodiments, the configuration shown in FIG. 3 may allow the orthodontic retainer 220 to operate as a placement structure by which the medicament 210 may be delivered to the gingival crevice 550 and then left in place after removal of the orthodontic retainer 220. In additional or alternative embodiments, however, the medicament 210 may remain associated with the orthodontic retainer 220 for at least a period of time while the orthodontic retainer 220 remains seated on the teeth, such that release of the medicament 210 may occur while the orthodontic retainer 220 is still being worn. In such embodiments, the orthodontic retainer 220 may not be removed immediately after initial seating, but may instead remain in position long enough for the medicament 210 to dissolve, diffuse, transfer, or otherwise be released into the gingival crevice 550.

In embodiments, the operation illustrated in FIG. 3 may be carried out in different ways depending on the nature of the medicament 210, the manner in which the medicament 210 is associated with the orthodontic retainer 220, and/or the intended therapeutic result. For example, in some embodiments, the orthodontic retainer 220 may be removed shortly after the medicament 210 has been positioned relative to the gingival crevice 550. In these embodiments, the orthodontic retainer 220 may function primarily as a placement structure configured to bring the medicament 210 to the target site and to leave the medicament 210 deposited within or adjacent to the gingival crevice 550 upon removal of the orthodontic retainer 220. This configuration may be advantageous where the medicament 210 is intended to remain at the treatment site as a deposited body after the orthodontic retainer 220 has been withdrawn, such as where the medicament 210 is configured to stay within the gingival crevice 550 and subsequently release its active substance while no longer being supported by the orthodontic retainer 220.

In additional or alternative embodiments, the orthodontic retainer 220 may remain seated on the teeth for a predetermined period rather than being removed shortly after initial placement. For example, the orthodontic retainer 220 may remain seated for a period of seconds, minutes, hours, or another selected treatment interval sufficient to allow the medicament 210 to be released while the orthodontic retainer 220 remains in position. In embodiments, maintaining the orthodontic retainer 220 in its seated position for a predetermined period may allow the orthodontic retainer 220 to continue to hold the medicament 210 in a desired positional relationship with the gingival crevice 550 during the release process. This may be advantageous where prolonged contact, gradual release, repeated exposure, or a more controlled transfer of medicament is desired. In embodiments, the duration for which the orthodontic retainer 220 remains seated may be selected based on the formulation of the medicament 210, the target delivery site, the desired release kinetics, patient comfort considerations, and/or other treatment parameters.

In embodiments, the medicament 210 associated with the orthodontic retainer 220 may be configured to release medicament by any suitable release mechanism. For example, the medicament 210 may release by dissolution, such as where the medicament 210 gradually dissolves in the oral environment after being brought into contact with gingival tissues or fluids. In embodiments, the medicament 210 may release by diffusion, such as where a medicament contained within a coating, matrix, body material, or deposited form migrates outwardly over time. In embodiments, the medicament 210 may release by detachment, such as where a deposited portion of the medicament 210 separates from the orthodontic retainer 220 during seating or removal and remains within the gingival crevice 550. In embodiments, the medicament 210 may release by transfer, such as where contact between the medicament 210 and the tissues adjacent the gingival crevice 550 causes the medicament 210 to adhere to, spread along, or otherwise move to the treatment site. In additional or alternative embodiments, any other suitable release mechanism may be used, including partial release, staged release, sustained release, immediate release, delayed release, or combinations thereof.

In embodiments, the medicament 210 may be configured in any suitable physical form that may allow the medicament 210 to be carried by the orthodontic retainer 220 and delivered to the gingival crevice 550. For example, the medicament 210 may be configured as a seed, a coating, a gel, a paste, a film, a matrix, a deposit, a bead, a layer, a strip, a patch, a semi-solid body, a dissolvable body, a viscous body, and/or another medicament-containing form. In embodiments, the particular physical form of the medicament 210 may influence whether the medicament 210 is more suitable for rapid deposition and removal of the orthodontic retainer 220, or for longer seated retention of the orthodontic retainer 220 during release. For example, a deposited medicament seed or semi-solid body may be particularly suitable where the medicament 210 is intended to remain at the gingival crevice 550 after the orthodontic retainer 220 is removed, while a coating, film, or matrix associated with the orthodontic retainer 220 may be particularly suitable where the orthodontic retainer 220 remains seated while the medicament 210 dissolves, diffuses, or otherwise releases.

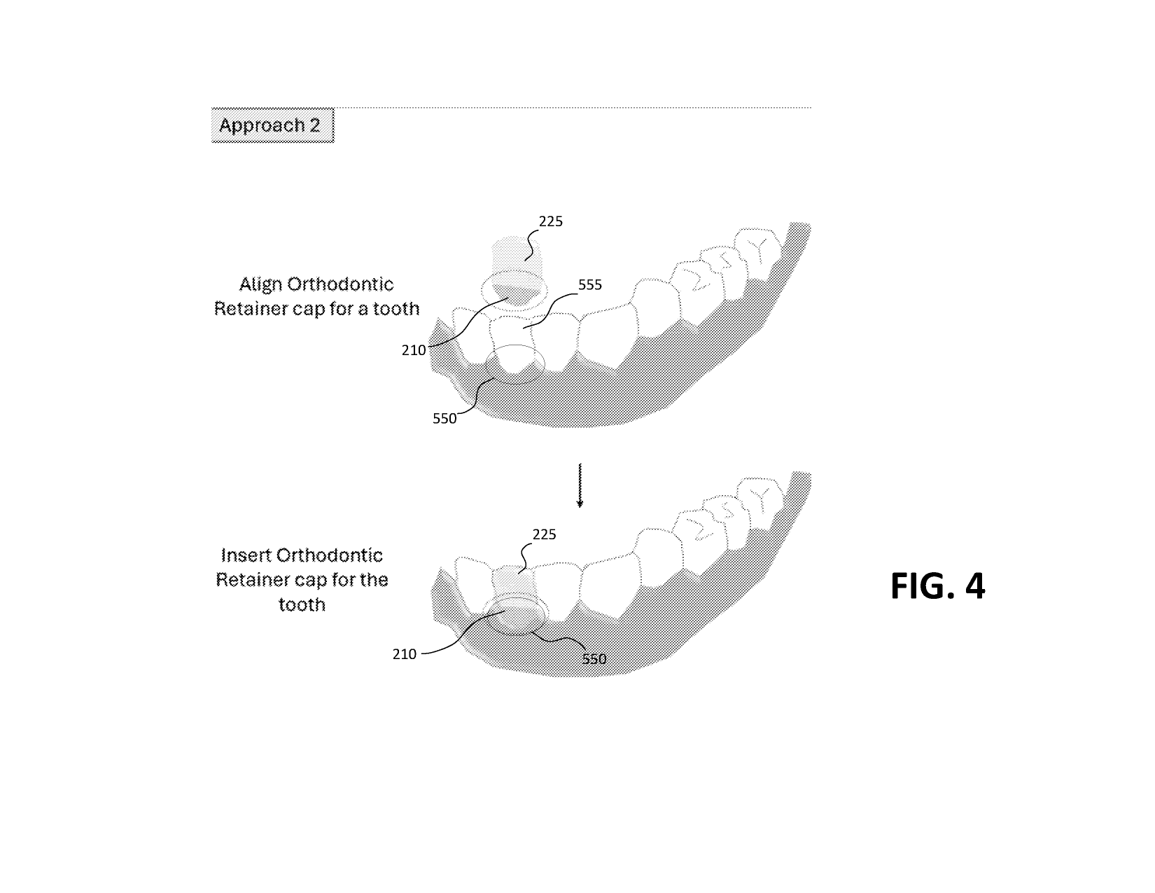

FIG. 4 shows a diagram illustrating an example of a customized orthodontic device configured for delivery of medicament to a gingival crevice of a patient for absorption through a junctional epithelium in accordance with embodiments of the present disclosure. As shown in FIG. 4, the orthodontic device is configured as a cap 225 for a single tooth 555 rather than as a full-arch orthodontic retainer extending over multiple teeth. In embodiments, the cap 225 may be configured to fit over the crown or exposed portion of the single tooth 555 in a custom-fitted manner such that the cap 225 may be repeatedly seated in a predictable position relative to the tooth 555 and the adjacent gingival crevice 550. In embodiments, the medicament 210 may be carried by the cap 225 in a manner similar to that described above with respect to the orthodontic retainer 220, except that the cap 225 may be configured to localize the medicament delivery function to a single selected tooth site.

In embodiments, during an alignment stage, the cap 225 may be positioned relative to the tooth 555 before full seating of the cap 225 onto the tooth 555. During this alignment stage, the cap 225 may be brought into registration with the tooth 555 so that the medicament 210 carried by the cap 225 may be aligned with the gingival crevice 550 associated with that tooth 555. In embodiments, because the cap 225 may be configured specifically for the geometry of the single tooth 555, the cap 225 may define a predetermined seating orientation and position relative to that tooth 555. As a result, once the cap 225 is brought into general alignment with the tooth 555, the medicament 210 carried by the cap 225 may also be correspondingly aligned with the gingival crevice 550 without requiring the user to separately position the medicament 210 through freehand manipulation. In embodiments, this fitted relationship between the cap 225 and the tooth 555 may allow the cap 225 to function as a localized targeting and placement structure for the medicament 210.

In embodiments, during a seating stage in which the cap 225 is inserted onto and seated over the tooth 555. As the cap 225 is advanced onto the tooth 555, the medicament 210 carried by the cap 225 may be moved into or into close proximity with the gingival crevice 550. In embodiments, seating of the cap 225 may cause the medicament 210 to enter the gingival crevice 550, to face the gingival crevice 550, to engage tissue adjacent the gingival crevice 550, and/or otherwise to communicate with the gingival crevice 550 in a manner that facilitates medicament delivery. In embodiments, because the cap 225 may be fitted to a single tooth 555, the cap 225 may provide a highly localized seating relationship that may be useful where delivery to one selected gingival crevice 550 is desired. In embodiments, the cap 225 may be configured to remain on the tooth 555 for a selected treatment interval, or may be configured for shorter placement depending on the form and release behavior of the medicament 210.

In embodiments, the cap 225 may be used in a manner similar to the orthodontic retainer 220 described above, but with the functional distinction that the cap 225 may be directed to a single-tooth treatment site rather than to a broader multi-tooth arrangement. For example, in embodiments, the cap 225 may be placed over the tooth 555, may position the medicament 210 relative to the gingival crevice 550, and may thereafter be removed while leaving at least a portion of the medicament 210 deposited within or adjacent to the gingival crevice 550. In additional or alternative embodiments, the cap 225 may remain seated on the tooth 555 for a predetermined period while the medicament 210 dissolves, diffuses, transfers, detaches, and/or otherwise releases into the gingival crevice 550. In embodiments, the cap 225 may be useful where treatment is intended for a single selected gingival crevice 550, where a more localized appliance is preferred over a full-arch appliance, where patient comfort or simplicity of use may favor a smaller device, and/or where only one selected tooth site requires treatment.

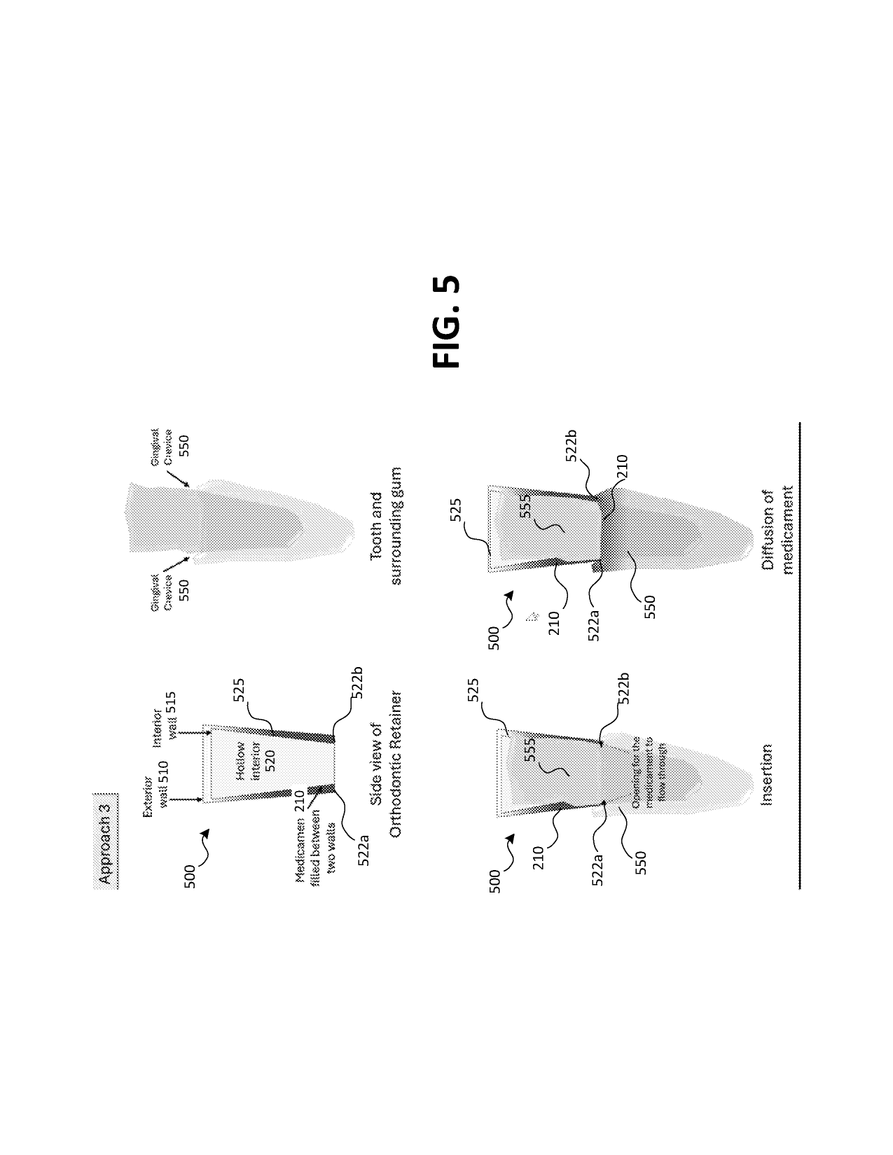

FIG. 5 illustrates another embodiment of a customized orthodontic device 500 configured with functionality for delivery of medicament to a gingival crevice of a patient for absorption through a junctional epithelium in accordance with embodiments of the present disclosure. In embodiments, the orthodontic device 500 may be configured as a reservoir-style cap having a double-wall structure. For example, the orthodontic device 500 may include an exterior wall 510 and an interior wall 515 arranged to define a reservoir 525 therebetween. In embodiments, the orthodontic device 500 may be configured to fit over a tooth 555 in a cap-like manner while also carrying medicament 210 for delivery into the gingival crevice 550. For example, the orthodontic device 500 may be configured such that the medicament 210 is received and retained within the reservoir 525 defined by the exterior wall 510 and the interior wall 515 of the orthodontic device 500. This configuration may allow the orthodontic device 500 to operate not only as a positioning structure, but also as a reservoir-bearing delivery structure configured to bring the medicament 210 to the target site and release the medicament 210 in a controlled manner.

In embodiments, the orthodontic device 500 may include a hollow interior 520 configured to receive the tooth 555 when the orthodontic device 500 is seated thereon. In embodiments, the hollow interior 520 may correspond to the interior cap space that extends over the tooth 555 and conforms generally to the outer shape of the tooth 555 so that the orthodontic device 500 may be seated in a stable and repeatable manner. In embodiments, the orthodontic device 500 may define a reservoir 525 associated with the wall structure of the orthodontic device 500. In embodiments, the reservoir 525 may be defined between the exterior wall 510 and the interior wall 515 such that the medicament 210 may be positioned between the exterior wall 510 and the interior wall 515 rather than solely within the tooth-receiving hollow interior 520. As shown, the medicament 210 may be carried in the wall region of the orthodontic device 500, where the medicament 210 may be retained before seating of the orthodontic device 500 and thereafter released at the intended treatment location. In embodiments, the outlets 522a and 522b may correspond to lower outlet or terminal regions of the orthodontic device 500 near the gingival margin, and these outlets 522a and 522b may be configured to be brought into proximity with, or into the region of, the gingival crevice 550 when the orthodontic device 500 is placed over the tooth 555, and allow the medicament 210 to be extruded or escape from the reservoir 525 to be deposited into the gingival crevice (e.g., the apical aspect of the gingival crevice) for absorption through the junctional epithelium.

In embodiments, the double-wall structure of the orthodontic device 500 may define a compartment, cavity, chamber, hollow interior 520, and/or reservoir 525 configured to carry the medicament 210 before delivery. For example, the exterior wall 510 and the interior wall 515 may be spaced apart from one another such that the region therebetween defines the reservoir 525, which may be a medicament-containing volume within the orthodontic device 500. In embodiments, the medicament 210 may be loaded into the reservoir 525 in any suitable form, such as a liquid, gel, paste, viscous material, semi-solid material, dissolvable material, and/or other medicament-containing form capable of being retained within the reservoir structure before use. In embodiments, the wall geometry may be configured such that the medicament 210 remains substantially contained within the reservoir 525 until the orthodontic device 500 is seated on the tooth 555 and positioned relative to the gingival crevice 550.

In embodiments, the orthodontic device 500 may be configured such that, when the orthodontic device 500 is seated over the tooth 555, the outlets 522a and 522b may be positioned near, at, within, or partially within the gingival crevice 550. In this manner, the outlets 522a and 522b may be configured as openings to the reservoir 525 through which the medicament 210 may flow, migrate, diffuse, or otherwise flow out of the reservoir 525 toward the gingival crevice 550. In embodiments, positioning the outlets 522a and 522b at the gingival region may allow the medicament 210 carried between the exterior wall 510 and the interior wall 515 to be released close to the desired treatment site rather than at a location remote therefrom.

In embodiments, operation of the orthodontic device 500 may include insertion and seating relative to the tooth 555 and the gingival crevice 550. For example, the orthodontic device 500 may first be aligned with the tooth 555, and thereafter the orthodontic device 500 may be advanced onto the tooth 555 until the orthodontic device 500 reaches a seated position. As the orthodontic device 500 is seated, the hollow interior 520 may receive the tooth 555, stabilizing the orthodontic device 500 relative to the tooth 555 and surrounding gingival anatomy. In embodiments, because the orthodontic device 500 may be custom-fitted to the tooth 555, seating of the orthodontic device 500 may repeatedly position the outlets 522a and 522b at a desired location near the gingival margin, near the gingival crevice 550, or within the gingival crevice 550. This may allow the orthodontic device 500 to act as a positional guide for bringing the medicament 210 to the target region in a controlled and repeatable manner.

In embodiments, when the orthodontic device 500 is fully seated, the outlets 522a and 522b may be positioned proximate to, adjacent to, fully within, or partially within the gingival crevice 550. In this seated configuration, the outlets 522a and 522b may define or border an opening, release path, outlet region, or terminal discharge region through which the medicament 210 carried within the reservoir 525 may move toward the gingival crevice 550. For example, the medicament 210 may flow, migrate, diffuse, seep, extrude, or otherwise move out of or from the reservoir 525 through or adjacent the outlets 522a and 522b and into the gingival crevice 550. In embodiments, the seated relationship between the orthodontic device 500 and the tooth 555 may place the outlets 522a and 522b in a position that facilitates localized delivery to the gingival crevice 550 rather than release at a more coronally spaced or anatomically remote location. In some embodiments, the outlets 522a and 522b may be dissolvable such that the outlets 522a and 522b may be configured to prevent the medicament 210 from escaping from the reservoir 525 prior to insertion into the gingival crevice 550, but may dissolve once the device 500 is inserted into the gingival crevice 550 allowing the medicament 210 from escaping from or flowing out of the reservoir 525 and into the gingival crevice 550.

In some embodiments, release of the medicament 210 from the orthodontic device 500 may occur through dissolution or degradation of at least a portion of the wall structure of the orthodontic device 500. For example, one of the walls of the orthodontic device 500 may be configured as a dissolvable wall while another portion of the orthodontic device 500 remains sufficiently intact to provide support and maintain positional stability on the tooth 555. In embodiments, the exterior wall 510 may be configured to be dissolvable, degradable, erodible, permeable after hydration, or otherwise releasable in response to conditions present in the oral environment, while the interior wall 515 may remain more structurally intact so that the orthodontic device 500 may continue to be supported relative to the tooth 555 during at least a portion of the release interval.

In embodiments, dissolution, degradation, erosion, rupture, thinning, perforation, or other structural compromise of the exterior wall 510 may allow the medicament 210 to be released from the reservoir 525 into the gingival crevice 550. Because the interior wall 515 may remain in place adjacent the tooth 555, the remaining wall structure may continue to help support and position the orthodontic device 500 while the medicament 210 is being discharged. In embodiments, this double-wall configuration may advantageously direct release toward the targeted gingival tissues rather than away from the treatment site. For example, because the medicament 210 may be contained in the wall region of the orthodontic device 500 and because the outlets 522a and 522b may be positioned near the gingival crevice 550 when seated, release of the medicament 210 may occur in a direction toward the gingival crevice 550 and toward the underlying gingival tissues, including in embodiments toward the junctional epithelium.

In embodiments, the reservoir 525 of the orthodontic device 500 may be configured to hold the medicament 210 in a wide variety of physical forms depending on the desired release behavior, retention characteristics, manufacturing approach, and/or therapeutic objective. For example, the reservoir 525 may hold the medicament 210 in the form of a liquid, a gel, a paste, a solid, a semi-solid, a highly viscous material, an amorphous solid, or a medicament seed. In embodiments, the physical form of the medicament 210 retained within the reservoir 525 may be selected to influence the manner in which the medicament 210 is discharged from the orthodontic device 500 and thereafter retained relative to the gingival crevice 550. For example, a more flowable material may be suitable where the medicament 210 is intended to migrate or flow through an outlet-adjacent region once the orthodontic device 500 is seated, while a more viscous, semi-solid, or seed-like material may be suitable where the medicament 210 is intended to remain more localized after release.

In some embodiments, the orthodontic device 500 may include more than one reservoir 525. For example, multiple reservoirs may be positioned at different regions of the orthodontic device 500 so that medicament 210 may be delivered to more than one location relative to the same tooth 555 or relative to different treatment sites. In embodiments, separate reservoirs may be positioned on opposite sides of the orthodontic device 500, may be positioned at different circumferential regions around the tooth-receiving hollow interior 520, or may be arranged in stacked, segmented, compartmentalized, or otherwise separated configurations. In embodiments, multiple reservoirs may each contain the same medicament 210, different medicaments 210, different concentrations of the same medicament 210, and/or different physical forms of the medicament 210. This may allow the orthodontic device 500 to provide more complex delivery profiles, such as multi-site release, staged release, multi-dose release, and/or release of different therapeutic substances to different gingival regions.

In embodiments, different teeth may be associated with different reservoir structures. For example, where a plurality of teeth are to be treated using multiple single-tooth orthodontic devices 500 or using a larger orthodontic device having multiple tooth-associated portions, one tooth may be associated with a first reservoir configuration while another tooth may be associated with a second reservoir configuration. In embodiments, a first tooth may use a larger reservoir 525 for increased medicament volume, while a second tooth may use a smaller or narrower reservoir 525 for a more localized application. In embodiments, one tooth may use a single reservoir while another tooth may use multiple reservoirs. In embodiments, one tooth may use a reservoir configured for rapid release while another tooth may use a reservoir configured for slower or more sustained release. In this manner, the reservoir concept disclosed herein may be customized not only to the anatomy of the patient, but also to the particular treatment needs of different teeth or different gingival crevices within the same patient.

In embodiments, the exterior wall 510, the interior wall 515, and other portions of the orthodontic device 500 may be formed from different materials, may have different thicknesses, and may have different dissolution rates or degradation characteristics. For example, the exterior wall 510 may be configured to dissolve relatively quickly after exposure to oral fluids so that the medicament 210 may be released soon after the orthodontic device 500 is seated, while the interior wall 515 may be configured to remain substantially intact for a longer period so that the orthodontic device 500 may continue to be supported on the tooth 555 during delivery. In embodiments, one wall may be thinner than another wall to encourage preferential dissolution, erosion, rupture, weakening, or opening at a selected side of the reservoir 525. In embodiments, one wall may be formed from a more rigid material while another wall may be formed from a softer, more permeable, more degradable, or more dissolvable material. In embodiments, the selected material properties and thicknesses of the respective walls may be used to control the timing, direction, rate, and manner of release of the medicament 210 from the hollow reservoir 525.

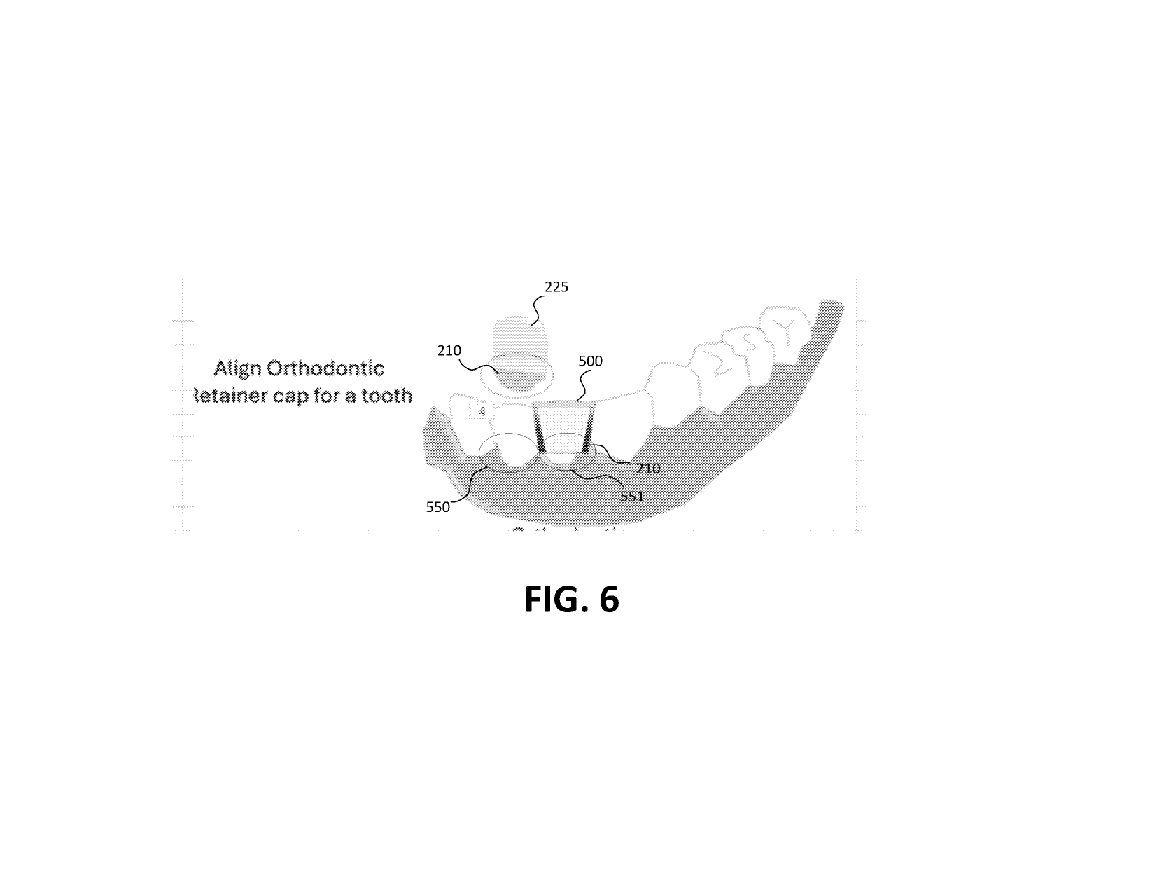

FIG. 6 is a diagram illustrating another embodiment of devices configured with functionality for delivery of medicament to a gingival crevice of a patient for absorption through a junctional epithelium in accordance with embodiments of the present disclosure. In embodiments, the configuration shown in FIG. 6 may allow an orthodontic delivery structure to concurrently or sequentially target multiple gingival crevices associated with different teeth. As shown, FIG. 6 may include a cap 225 carrying medicament 210 at one treatment site and an orthodontic device 500 carrying medicament 210 at another treatment site. In embodiments, the cap 225 may be associated with a first gingival crevice 550, while the orthodontic device 500 may be associated with a second gingival crevice 551.

In embodiments, the multi-site configuration of may provide flexibility in how different gingival crevices are treated. For example, the same medicament 210 may be delivered to multiple gingival crevices where a common therapeutic effect is desired at each site. In additional or alternative embodiments, different medicaments 210 may be delivered to different gingival crevices. For example, one gingival crevice may receive an antimicrobial medicament while another gingival crevice may receive an anti-inflammatory medicament, a nutrient, a vaccine-related material, or another therapeutic substance. In embodiments, even where the same medicament 210 is used at multiple sites, the amount of medicament 210 provided at each site may differ. In this manner, one site may receive a larger dosage while another site may receive a smaller dosage, depending on the treatment objective associated with the respective teeth and gingival crevices.

In embodiments, the delivery mechanisms used at different sites may also differ within the same overall treatment arrangement. For example, one site may use a cap 225 carrying medicament 210 in a more surface-associated form, while another site may use an orthodontic device 500 configured with a reservoir-type structure or another release architecture. In embodiments, one medicament-bearing region 210 may be configured for deposition and subsequent removal of the supporting structure, while another medicament-bearing region 210 may be configured for sustained release while its supporting structure remains seated for a selected period.

In embodiments, the multi-site delivery functionality may be implemented using a variety of orthodontic structures. For example, the structures used for multi-site delivery may include multiple single-tooth caps, one or more localized orthodontic devices, a partial-arch orthodontic structure, or a full-arch orthodontic structure configured to carry medicament at multiple positions along the dental arch. In embodiments, a full-arch device may carry multiple medicament-bearing regions 210 distributed across a plurality of tooth-corresponding regions, while in other embodiments a partial-arch device may carry medicament-bearing regions 210 only at selected segments of the arch. In still other embodiments, a combination of different structures may be used together, such as a cap 225 at one site and an orthodontic device 500 at another site.

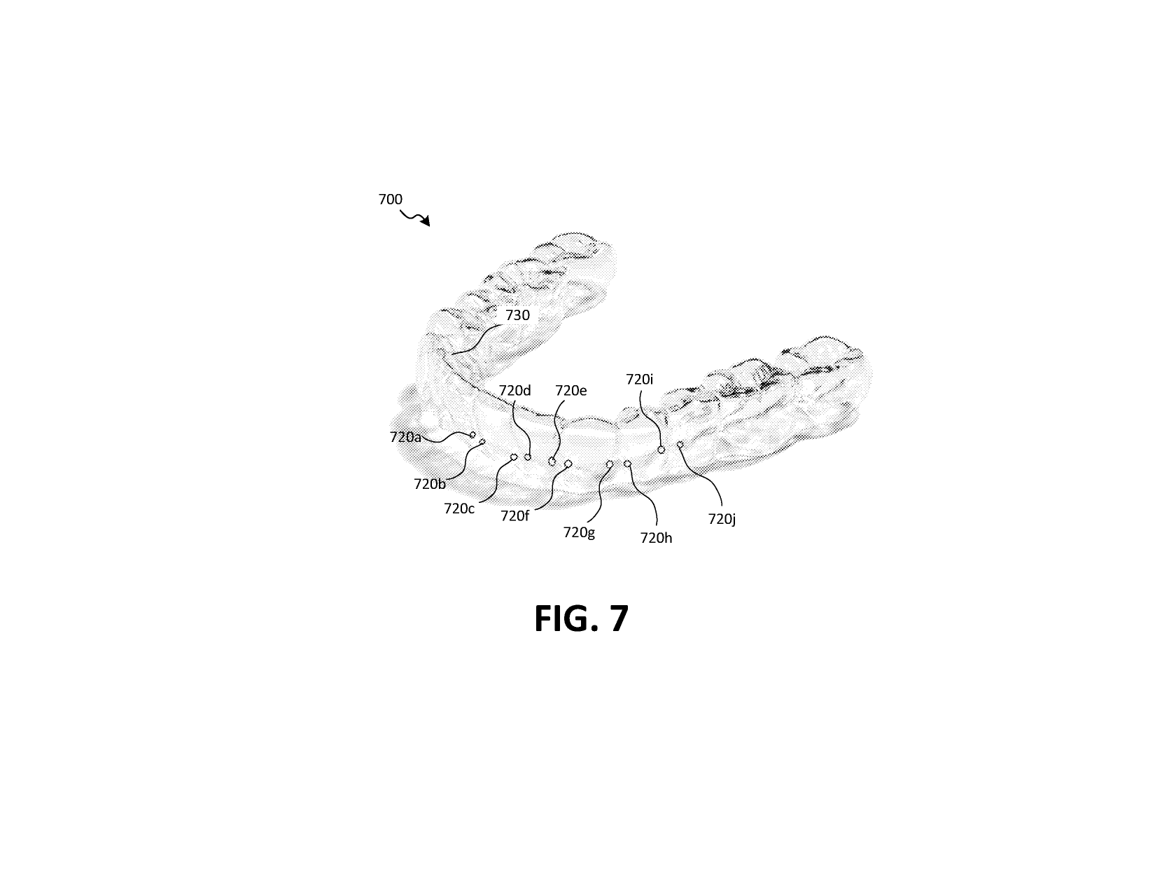

FIG. 7 is a diagram illustrating a targeting device 700 configured with functionality for delivery of medicament to a gingival crevice of a patient for absorption through a junctional epithelium in accordance with embodiments of the present disclosure. In embodiments, the targeting device 700 may be configured as a custom-fitted targeting retainer 730 shaped to conform to at least a portion of the dentition of a patient. In embodiments, the targeting retainer 720 may be configured to establish one or more guided access locations relative to one or more selected gingival crevices. In embodiments, the targeting retainer 730 may operate as a positional guide that helps direct a separate medicament delivery structure, such as a cartridge, nozzle, tip, or other delivery component, toward a selected target site within the oral cavity. In this manner, the targeting retainer 730 may provide the positional advantages of a custom-fitted orthodontic appliance while allowing the medicament itself to be delivered by a separate structure.

In embodiments, the targeting retainer 730 may be configured to position one or more targeting holes (e.g., targeting holes 720a-720j) relative to one or more gingival crevices so that, when the targeting retainer 730 is seated on the patient’s teeth, the targeting holes may align with desired delivery sites. In this manner, the targeting retainer 730 may define one or more access paths extending through the body of the targeting retainer 730, and these access paths may allow a separate medicament delivery structure to be guided to a selected gingival crevice with improved positional accuracy.

In embodiments, the targeting device 700 may include the targeting retainer 730 and a plurality of targeting holes 720a-720j formed through the body of the targeting retainer 730. The targeting retainer 730 may be custom-fitted to the patient in a manner similar to the previously described orthodontic structures, such that the targeting retainer 730 may be repeatedly seated in a predictable position relative to the patient’s dentition. In embodiments, the targeting holes 720a-720j may be formed at selected locations along the targeting retainer 730 corresponding to selected teeth, selected interproximal regions, selected gingival margins, and/or selected gingival crevices. In embodiments, each targeting hole 720a-720j may define an opening through which a separate delivery structure may pass, or toward which a separate delivery structure may be guided, in order to deliver medicament toward an intended treatment site.

In embodiments, the targeting holes 720a-720j may be positioned near the gingival margin at selected tooth locations so that each targeting hole may correspond to a particular gingival crevice or group of gingival crevices. For example, one targeting hole may be positioned adjacent a first tooth site, another targeting hole may be positioned adjacent a second tooth site, and so on across the targeting retainer 730. In embodiments, the targeting holes 720a-720j may be arranged to correspond to only selected treatment sites rather than every tooth location, or may be distributed across a broader portion of the targeting retainer 730 where it is desired to provide access to multiple possible gingival target sites. In embodiments, because the targeting retainer 730 may be custom-fitted to the patient’s anatomy, seating of the targeting retainer 730 may repeatedly place the targeting holes 720a-720j in substantially the same positional relationship relative to the selected teeth and associated gingival crevices. In this manner, the targeting device 700 may provide a customized targeting architecture by which the targeting retainer 730 may operate as an anatomical guide for subsequent medicament delivery through one or more of the targeting holes 720a-720j.

In embodiments, the targeting holes 720a-720j may operate as guides, access ports, delivery openings, targeting apertures, or positioning features through which a separate medicament delivery device may be directed. For example, each targeting hole 720a-720j may define a physical opening through the targeting retainer 730 that provides access toward an underlying gingival crevice. In embodiments, the walls of a selected targeting hole may help orient, guide, center, or constrain a separate delivery structure as that delivery structure is advanced toward the gingival region. In embodiments, the targeting holes 720a-720j may reduce the difficulty of manually locating and accessing a selected gingival crevice by providing a fitted structural reference point from which medicament delivery may proceed. In embodiments, a separate medicament delivery device may be inserted through a selected targeting hole, advanced toward the intended gingival crevice, and thereafter actuated or otherwise used to deliver medicament to the target site.

In embodiments, the targeting retainer 730 may be manufactured using patient-specific information derived from one or more impressions, scans, models, or digital dental data sets. For example, the targeting retainer 730 may be fabricated based on a physical dental impression, a cast, a mold, an intraoral scan, a three-dimensional digital model, and/or another anatomical representation of the patient’s dentition. In embodiments, the targeting retainer 730 may be thermoformed, molded, machined, printed, three-dimensionally printed, and/or otherwise fabricated using any suitable manufacturing process.

In embodiments, the targeting holes 720a-720j may be incorporated into the targeting retainer 730 in any suitable manner. For example, the targeting holes 720a-720j may be predesigned as part of a digital model, may be formed during molding or printing of the targeting retainer 730, or may be subsequently drilled, cut, machined, punched, laser-formed, or otherwise created in the targeting retainer 730 after at least a portion of the targeting retainer 730 has been fabricated. In embodiments, the targeting retainer 730 may be formed from a clear material to permit visual inspection of underlying anatomical structures during use, or may be formed from an opaque or partially translucent material depending on the intended implementation. In embodiments, the targeting retainer 730 may be reusable, such that the same targeting retainer 730 may be seated on the patient’s teeth over multiple treatment sessions to provide repeatable access to the same selected gingival crevices.

In embodiments, the targeting holes 720a-720j may vary in diameter, size, cross-sectional geometry, depth, contour, and other structural characteristics. For example, a targeting hole may be relatively small where only a fine delivery tip is to be guided therethrough, or may be larger where a broader nozzle or another delivery structure is to be received. In embodiments, the targeting holes 720a-720j may be circular, oval, slot-like, tapered, keyed, polygonal, elongated, curved, or otherwise shaped depending on the desired fit with a corresponding medicament delivery structure and the anatomical site being targeted. In embodiments, a selected targeting hole may be tapered inwardly or outwardly to assist in guiding a delivery device, may include a keyed geometry to control angular orientation of a corresponding tip, or may include other shape features configured to improve alignment or insertion control. Accordingly, the targeting holes 720a-720j may be individually tailored not only to the target gingival location, but also to the particular delivery device intended to be used therewith.

In embodiments, the targeting retainer 730 may include any suitable number of targeting holes 720a-720j. For example, the targeting retainer 730 may include a single targeting hole for one selected gingival crevice, a plurality of targeting holes for several selected gingival crevices, or a larger array of targeting holes distributed across a substantial portion of the targeting retainer 730 to provide access to many possible treatment sites. In embodiments, the targeting holes may be arranged symmetrically or asymmetrically, may be limited to one side of the dental arch, may be distributed across anterior and posterior regions, or may otherwise be positioned according to the intended treatment pattern. In embodiments, one targeting retainer 730 may be configured to target one gingival crevice, several gingival crevices, or many gingival crevices depending on the needs of the patient and the treatment protocol.

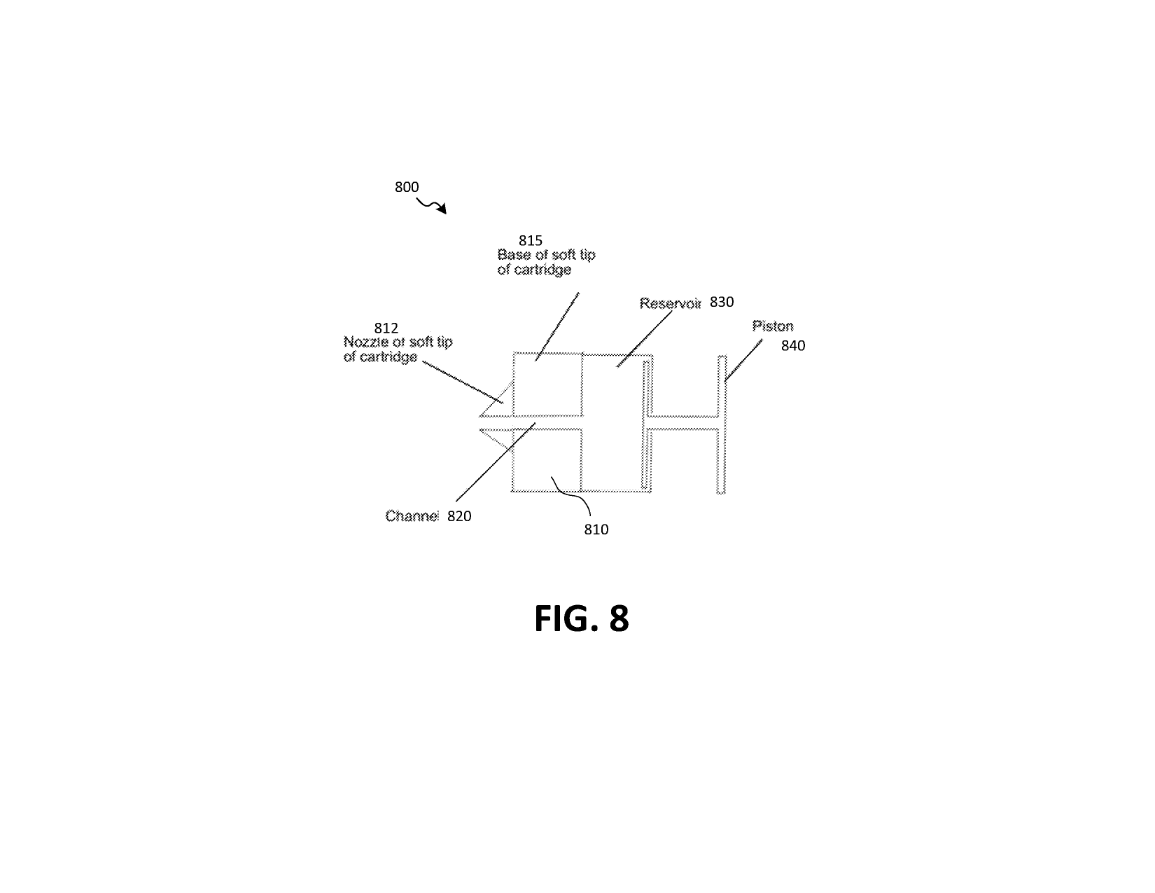

FIG. 8 is a diagram illustrating an example of a cartridge 800 configured to deliver medicament to a gingival crevice of a patient for absorption through a junctional epithelium in accordance with embodiments of the present disclosure. In embodiments, the cartridge 800 may be configured to deliver medicament through a selected targeting hole of a targeting retainer (e.g., the targeting retainer 700). In embodiments, the cartridge 800 may define a self-contained medicament delivery structure that may be used in combination with a targeting retainer so that the targeting retainer provides anatomical alignment and the cartridge 800 provides controlled discharge of the medicament into the gingival crevice. In this manner, the cartridge 800 may cooperate with a targeting hole of the targeting retainer to facilitate delivery of medicament into a selected gingival crevice. As shown in FIG. 8, the cartridge 800 may include a nozzle 812, a base 815, a channel 820, a tip assembly 810, a reservoir 830, and a piston 840. In embodiments, these structures may cooperate to store medicament within the cartridge 800, guide the cartridge 800 relative to a targeting hole, and discharge the medicament toward a target gingival crevice in a controlled manner.

In embodiments, the nozzle 812 and the base 815 may together define at least a portion of the tip assembly 810 of the cartridge 800. The nozzle 812 may be configured as the forward-most delivery portion of the cartridge 800 and may be shaped to facilitate insertion through a targeting hole of the targeting retainer. In embodiments, the nozzle 812 may include a narrowed, tapered, elongated, or otherwise reduced-dimension geometry that allows the nozzle 812 to pass through a targeting hole and approach the gingival crevice beneath the targeting retainer. The base 815 may be positioned proximally relative to the nozzle 812 and may define a broader support portion of the tip assembly. In embodiments, the base 815 may be configured to seat within, against, or otherwise relative to the targeting hole so that the base 815 may help position, stabilize, and orient the cartridge 800 during medicament delivery. For example, the base 815 may act as a stop, collar, support interface, registration feature, or alignment feature relative to the targeting hole so that the cartridge 800 may be inserted to a desired depth and held in a desired position while medicament is discharged. In some embodiments, the base 815 may be made of a soft material configured to conform to the shape of the retainer when the cartridge 800 is pressed against the targeting retainer, in order to provide a seal against the targeting retainer to prevent the medicament from escaping from the intended flow path toward the gingival crevice.

In embodiments, the channel 820 may extend through the tip assembly and may provide a flow path between the reservoir 830 and the distal outlet region of the nozzle 812. For example, the channel 820 may extend through the base 815 and into or through the nozzle 812 such that medicament located within the reservoir 830 may travel through the channel 820 and exit through the nozzle 812 during use. In embodiments, the channel 820 may be centrally located relative to the nozzle 812 and base 815, or may be offset depending on the desired discharge direction or cartridge geometry. In embodiments, the channel 820 may have a constant cross-section or may vary in diameter or shape along its length to influence flow characteristics of the medicament. For example, the channel 820 may narrow toward the nozzle 812 to assist in controlled discharge, or may have a wider proximal portion and a narrower distal portion.

In embodiments, the reservoir 830 may be configured to hold the medicament before discharge. The reservoir 830 may define an internal volume of the cartridge 800 in fluid communication with the channel 820 so that medicament stored in the reservoir 830 may be urged into the channel 820 during actuation of the cartridge 800. In embodiments, the reservoir 830 may be sized to hold a single dose, a partial dose, multiple doses, or another selected amount of medicament depending on the intended treatment protocol. In embodiments, the reservoir 830 may be configured to hold medicament in a wide variety of forms, including a liquid, gel, paste, suspension, highly viscous amorphous solid, semi-solid material, or another medicament-bearing material suitable for discharge through the channel 820 and nozzle 812. In embodiments, the internal geometry of the reservoir 830 may be selected to promote controlled movement of the medicament toward the channel 820 during actuation. For example, the reservoir 830 may be cylindrical, rectangular, tapered, stepped, or otherwise shaped to cooperate with the piston 840 and the medicament formulation.

In embodiments, the piston 840 may be configured to urge medicament from the reservoir 830 through the channel 820 and out of the nozzle 812. For example, the piston 840 may be advanced relative to the reservoir 830 to reduce the effective volume of the reservoir 830 and thereby apply pressure to the medicament contained therein. This pressure may cause the medicament to move from the reservoir 830 into the channel 820 and through the nozzle 812 toward the target gingival crevice. In embodiments, the piston 840 may be manually driven, mechanically driven, actuator-driven, spring-assisted, screw-advanced, or otherwise advanced depending on the configuration of the overall delivery system. In embodiments, the piston 840 may define a plunger-like structure, a sliding wall, a compressive member, or another force-applying component configured to displace the medicament from the reservoir 830. In embodiments, the travel distance, diameter, shape, and fit of the piston 840 relative to the reservoir 830 may be selected based on the viscosity of the medicament and the amount of force needed to discharge the medicament through the nozzle 812.

In embodiments, the tip assembly 810 may include frame configured to contain, support, couple, align, or otherwise structurally integrate the nozzle 812, the base 815, the channel 820, the reservoir 830, and the piston 840. The tip assembly 810 may define the main body structure of the cartridge 800. In embodiments, the tip assembly 810 may provide rigidity sufficient to support insertion of the tip assembly through a targeting hole while also maintaining the structural relationship among the reservoir 830, the channel 820, and the piston 840. In embodiments, the tip assembly 810 may be formed as a one-piece body or may be assembled from multiple components joined together. In embodiments, the tip assembly 810 may include rigid portions, semi-rigid portions, soft portions, or combinations thereof depending on whether different structural regions of the cartridge 800 are intended to provide support, sealing, flexibility, or atraumatic contact.

In embodiments, the cartridge 800 may be implemented in different use and refill configurations. For example, the cartridge 800 may be a single-use cartridge intended to be discarded after one medicament delivery event. In additional or alternative embodiments, the cartridge 800 may be disposable after a limited number of uses, may be refillable with new medicament after use, or may be configured as a multi-dose cartridge capable of delivering medicament more than once before replacement.

In embodiments, the medicament carried by the cartridge 800 may take many different forms depending on the intended delivery behavior, including but not limited to a liquid, a gel, a paste, a suspension, a highly viscous amorphous solid, a semi-solid, or another material capable of being urged through the channel 820. In embodiments, the selection of cartridge configuration may depend on sterility considerations, dosing precision, manufacturing preferences, cost considerations, and the characteristics of the medicament.

In embodiments, the nozzle 812 and/or the base 815 may be configured to be atraumatic and soft so as to reduce the likelihood of irritation or injury during insertion through a targeting hole and advancement toward the gingival region. For example, the nozzle 812 and/or the base 815 may be formed from a soft polymer, elastomer, resilient material, compliant material, or another material selected to provide a gentler interface with the targeting retainer and/or gingival tissue. In embodiments, a softer tip assembly may be particularly useful where the cartridge 800 is intended to be inserted by a non-clinician user or where repeated treatments are contemplated. In embodiments, the softness and compliance of the nozzle 812 and/or the base 815 may also facilitate sealing engagement with the targeting retainer at or around the selected targeting hole. For example, upon insertion of the nozzle 812 and/or seating of the base 815 relative to the targeting hole, the soft material may conform to the surrounding geometry of the targeting retainer so as to reduce leakage paths and inhibit escape of the medicament during extrusion. In this manner, the compliant tip structure may not only reduce trauma, but may also help maintain directional discharge of the medicament toward the intended gingival crevice rather than allowing the medicament to escape coronally or laterally at the interface with the targeting retainer.

In additional or alternative embodiments, the tip geometry may vary. For example, the nozzle 812 may be round, flattened, oval, tapered, elongated, narrow, wide, symmetric, asymmetric, or otherwise shaped depending on the geometry of the targeting hole, the desired insertion path, the desired flow characteristics, and the anatomy of the target site. In embodiments, the base 815 may also vary in shape and may be configured as a collar, flange, stop surface, cylindrical base, keyed base, or other structure configured to cooperate with the targeting hole.

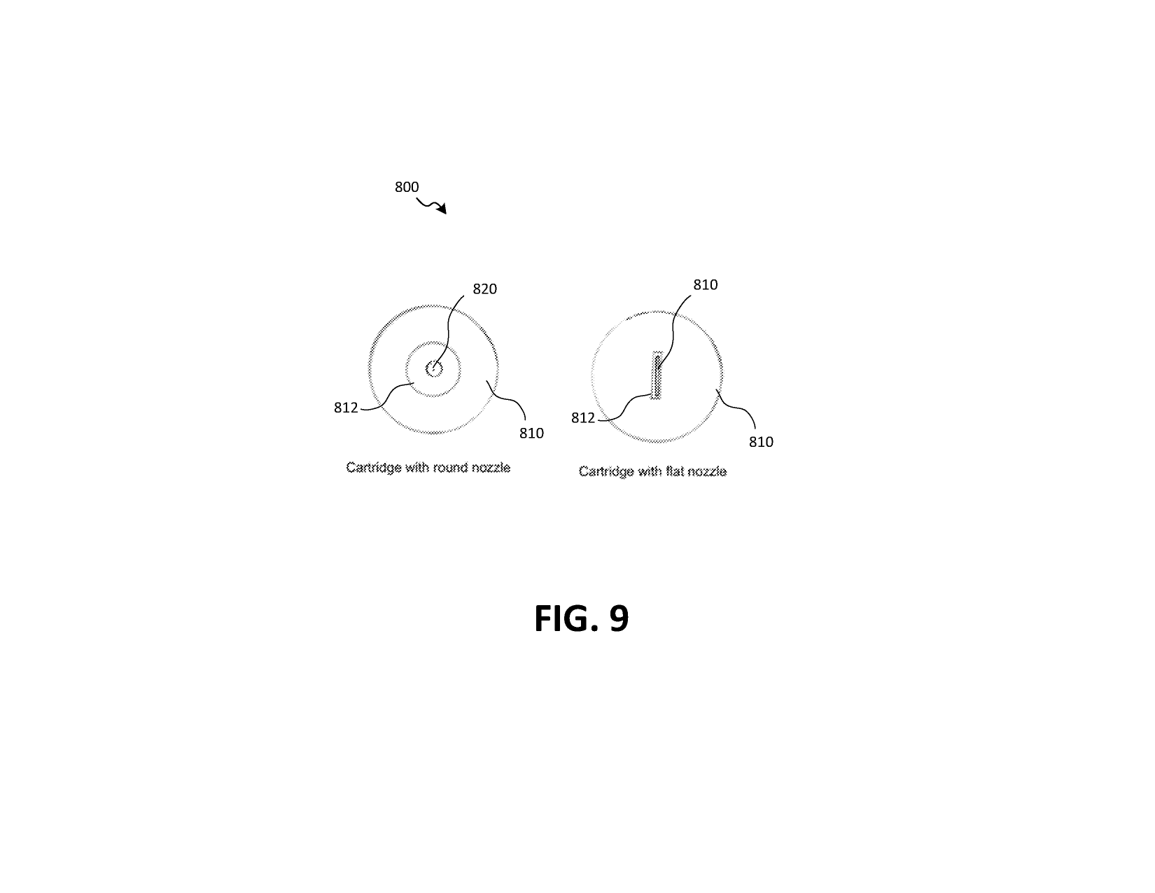

FIG. 9 illustrates front views of the cartridge 800 configured to deliver medicament to a gingival crevice of a patient for absorption through a junctional epithelium in accordance with embodiments of the present disclosure. As shown, the cartridge 800 may be implemented with different nozzle geometries depending on the intended application. For example, the cartridge 800 may include a round-nozzle embodiment and a flat-nozzle embodiment. In embodiments, the round-nozzle embodiment may include a generally circular nozzle 812 and a generally circular channel 820 arrangement. The flat-nozzle embodiment may include a nozzle 812 having a flatter, more elongated outlet geometry that differs from the more circular configuration of the round-nozzle embodiment.

In embodiments, the geometry of the nozzle 812 may be selected based on the geometry of the targeting hole with which the cartridge 800 is intended to be used. For example, where the targeting retainer includes a generally circular targeting hole, a round nozzle 812 may be advantageous because the round nozzle 812 may be more readily received within, centered by, and aligned relative to the circular opening. In embodiments, a round nozzle 812 may provide a more uniform radial relationship with a circular targeting hole and may facilitate insertion, centering, and controlled discharge through that targeting hole. In additional or alternative embodiments, where the targeting retainer includes a targeting hole having a slot-like, elongated, or otherwise non-circular configuration, a flat nozzle 812 may be advantageous because the flatter geometry of the nozzle 812 may better correspond to the shape of the targeting hole and may therefore provide improved fit, improved alignment control, or improved access characteristics.

In embodiments, the geometry of the nozzle 812 may be selected based on gingival-crevice access, insertion depth, patient comfort, medicament flow behavior, and/or another operational consideration. For example, a round nozzle 812 may be useful where a more centralized, compact, and symmetric insertion profile is desired. In embodiments, a round nozzle 812 may also be advantageous where the medicament is to be discharged in a relatively concentrated manner through a more centrally located outlet. In embodiments, a flat nozzle 812 may be useful where a shallower access path is desired, where a more elongated outlet may help distribute medicament along a narrower region, where the target anatomy suggests that a flatter insertion profile may improve access or comfort, and/or where multiple gingiva crevices are targeted. In embodiments, a flat nozzle 812 may also be useful where the targeting path is more slit-like or where it is desirable to reduce one cross-sectional dimension of the nozzle 812 while maintaining a different cross-sectional width for discharge.

In some embodiments, the nozzle 812 may be implemented with a tapered, elongated, curved, angled, beveled, narrowed, widened, and/or otherwise shaped depending on the intended targeting and discharge characteristics. In embodiments, the nozzle 812 may be formed from a soft material, a flexible material, or another compliant material so as to provide a more atraumatic interface during use. In embodiments, a softer or more flexible nozzle 812 may be advantageous where the nozzle 812 is intended to approach delicate gingival tissues or to be inserted by users with varying levels of experience. In embodiments, the cross-sectional geometry of the nozzle 812 may be circular, oval, elliptical, rectangular, slot-like, polygonal, keyed, or otherwise configured to correspond to a particular targeting hole arrangement or discharge profile. In embodiments, the dimensions of the nozzle 812 may also vary, including its width, thickness, diameter, length, taper, or outlet size.

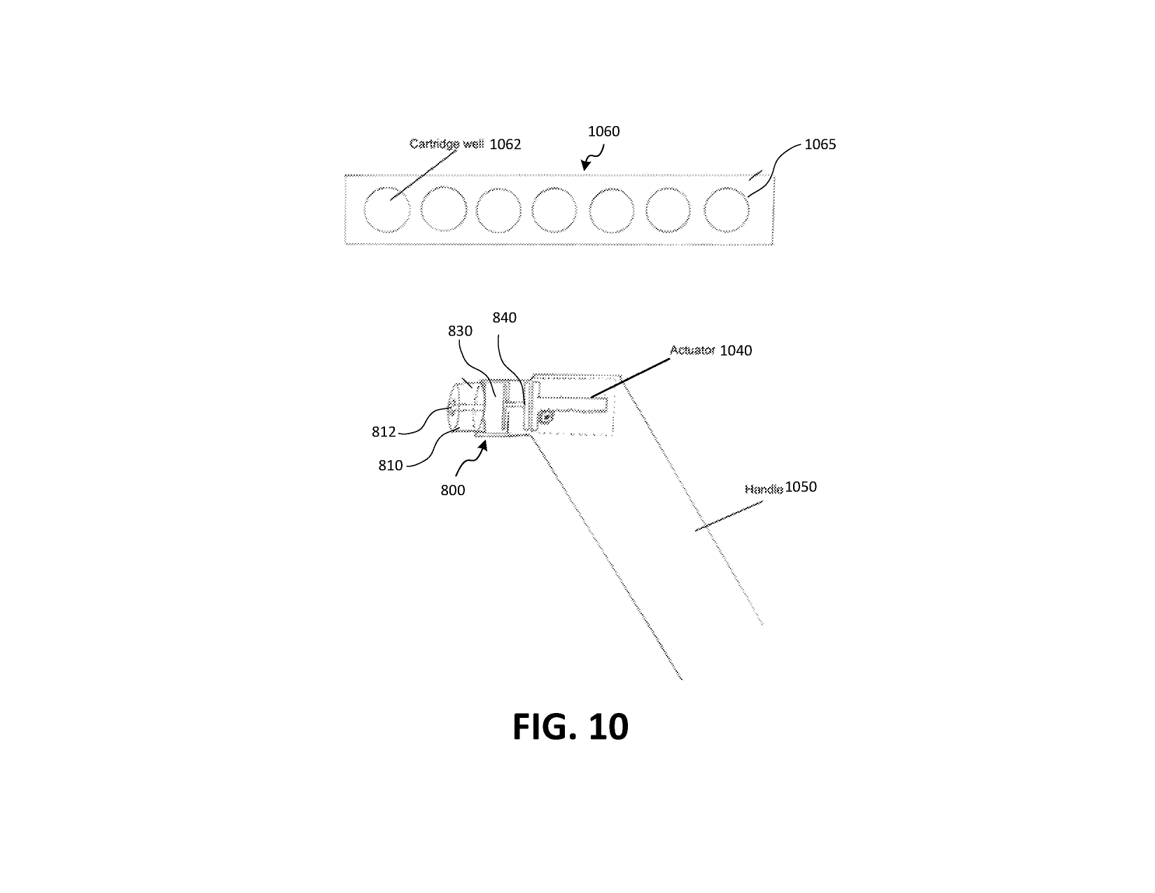

FIG. 10 illustrates an embodiment of a system 1000 configured for delivery of a medicament to a gingival crevice of a patient for absorption through a junctional epithelium in accordance with embodiments of the present disclosure. In embodiments, the system 1000 may include the cartridge 800, an actuator 1040, a handle 1050, and a tray system 1060. In embodiments, the system 1000 may be configured such that the cartridge 800 may be selectively coupled to the handle 1050 for use, while the actuator 1040 may be configured to operate upon the cartridge 800 in order to cause discharge of medicament therefrom. In embodiments, the tray system 1060 may be configured to hold one or more cartridges 800 before use (and in some embodiment after use) so that the system 1000 may provide not only a delivery structure, but also a loading and storage arrangement by which cartridges 800 may be organized and sequentially used. As further shown in FIG. 10, the tray system 1060 may include one or more cartridge wells 1062 and a multi-cartridge tray 1065. In embodiments, each of the cartridge wells 1062 may be configured to receive or hold a corresponding cartridge 800.

In embodiments, the system 1000 may be configured such that the cartridge 800 may operate as the medicament-containing discharge component, the handle 1050 may operate as a support and manipulation component, the actuator 1040 may operate as a force-applying component for causing medicament discharge, and the tray system 1060 may operate as a staging, storage, and loading component. In embodiments, the cartridge 800 may be removably associated with the handle 1050 so that a selected cartridge 800 may be picked up from one of the cartridge wells 1062 of the tray system 1060, coupled to the handle 1050, used for medicament delivery, and thereafter removed and replaced by another cartridge 800. In this manner, the system 1000 may support repeated medicament delivery operations while using a common handle 1050 and actuator 1040 with multiple cartridges 800 held in the tray system 1060.

In embodiments, the tray system 1060 may be configured to hold multiple cartridges 800 before use. For example, the tray 1065 of the tray system 1060 may define a support structure extending along a row, array, line, grid, or other arrangement, and the support structure may include a plurality of cartridge wells 1062 sized and shaped to receive corresponding cartridges 800. In embodiments, each cartridge well 1062 may store an individual cartridge 800 so that the cartridges 800 may be maintained in an organized and accessible manner prior to use. In embodiments, the cartridge wells 1062 may be spaced apart from one another to facilitate grasping, loading, and visual identification of the cartridges 800. In embodiments, the tray system 1060 may therefore function as a loading dock, cartridge organizer, storage tray, dispensing tray, or other support platform that maintains the cartridges 800 in a ready-to-use condition. In some embodiments, a used or depleted cartridge 800 may be stored onto a vacant cartridge well 1062, and in this manner the tray system 1060 may operate as a disposal tray for used cartridges.

In embodiments, the use of multiple cartridge wells 1062 in a single tray system 1060 may allow a user to perform multiple medicament delivery events during a session without needing to separately locate and handle loose cartridges 800 between uses. In embodiments, the tray system 1060 may hold cartridges 800 containing the same medicament, different medicaments, different dosages, or cartridges 800 intended for different treatment sites.

In embodiments, the handle 1050 may be configured to receive and support a selected cartridge 800. For example, the handle 1050 may include a receiving region, mount, recess, seat, socket, coupling feature, or other support structure configured to engage the cartridge 800 in a stable manner. In embodiments, once a selected cartridge 800 is associated with the handle 1050, the handle 1050 may support the cartridge 800 so that the cartridge 800 may be manipulated, positioned, inserted, and actuated during medicament delivery. In embodiments, the handle 1050 may provide a reusable support structure that allows a user to handle and operate the cartridge 800 more easily than if the cartridge 800 were manipulated directly by hand. In embodiments, the handle 1050 may also maintain the positional relationship of the cartridge 800 relative to the actuator 1040 so that, once the selected cartridge 800 is loaded into the handle 1050, the actuator 1040 may be properly positioned to operate on the cartridge 800 during use.

In embodiments, the handle 1050 may operate as a reusable user interface by which the cartridge 800 may be manipulated, positioned, and actuated. For example, the handle 1050 may provide a structure that a user may grasp, orient, and move during the loading and delivery process. In embodiments, because the handle 1050 may be larger and easier to manipulate than the cartridge 800 alone, the handle 1050 may improve ergonomics, improve control, and reduce the difficulty of positioning the cartridge 800 relative to the patient’s oral anatomy. In embodiments, the handle 1050 may be used repeatedly with multiple cartridges 800, such that the handle 1050 may be retained while individual cartridges 800 are loaded, used, removed, and replaced.

In embodiments, the actuator 1040 may be configured to engage the piston 840 of the cartridge 800 so as to cause medicament discharge during use. For example, once the cartridge 800 has been inserted into, mounted on, or otherwise supported by the handle 1050, the actuator 1040 may be positioned relative to the piston 840 such that operation of the actuator 1040 advances, pushes, drives, or otherwise urges the piston 840 into the cartridge 800. In embodiments, advancement of the piston 840 may reduce the effective volume of the reservoir 830 and may apply pressure to the medicament contained within the reservoir 830. This pressure may force the medicament from the reservoir 830 into the channel of the cartridge 800 and ultimately out through the nozzle 812. In this manner, the actuator 1040 may cooperate with the piston 840 and the reservoir 830 to provide controlled extrusion of the medicament through the nozzle 812 toward a selected target site, such as a gingival crevice aligned by the targeting retainer described herein.

In embodiments, the actuator 1040 may be configured to provide a user-controlled discharge event so that the amount, timing, and rate of medicament extrusion may be managed during treatment. For example, the actuator 1040 may be actuated after the nozzle 812 has been properly positioned relative to a selected targeting hole and target gingival crevice. In embodiments, the actuator 1040 may be configured to move the piston 840 through a selected stroke distance, to apply a selected force, and/or to provide a selected displacement sufficient to expel a desired amount of medicament from the reservoir 830.

In embodiments, the actuator 1040 may be configured as a manual actuator that is directly pressed, slid, squeezed, or otherwise moved by the user to engage the piston 840. In additional or alternative embodiments, the actuator 1040 may be spring-loaded so that stored spring force may be used to advance the piston 840 once released or triggered. In embodiments, the actuator 1040 may be configured as a trigger actuator, such that a trigger-like movement by the user causes the piston 840 to advance. In embodiments, the actuator 1040 may be configured as a screw actuator in which rotational movement is translated into linear advancement of the piston 840. In embodiments, the actuator 1040 may be configured as a powered actuator, such as a motor-driven or electronically driven actuator, where automated or assisted advancement of the piston 840 is desired.

In embodiments, the cartridge 800 may be inserted into or mounted on the handle 1050 prior to use. For example, the cartridge 800 may be loaded into a receiving portion of the handle 1050, may be snap-fit into the handle 1050, may be friction-fit into the handle 1050, may be slid into the handle 1050, and/or may otherwise be removably coupled to the handle 1050 in a manner that places the cartridge 800 in an operable relationship with the actuator 1040. In embodiments, once the cartridge 800 has been mounted on the handle 1050, the nozzle 812 may remain exposed at the forward end of the assembled system 1000 so that the nozzle 812 may be advanced toward the targeting retainer and the target gingival crevice, while the proximal portion of the cartridge 800, including the piston 840, may remain positioned for engagement by the actuator 1040.

In embodiments, the system 1000 may be provided as a single-cartridge implementation, in which the handle 1050 may be used with one cartridge 800 at a time and may be reloaded after each treatment event or after each selected site is treated. In some embodiments, the system 1000 may be provided as a multi-cartridge implementation, in which the handle 1050 may be used with multiple cartridges 800, which may be used at a time, in sequence after each treatment event or after each selected site is treated. In additional or alternative embodiments, the system 1000 may be used in conjunction with the tray 1060 and the multi-cartridge tray 1065 so that multiple cartridges 800 may be sequentially loaded onto the same handle 1050 during a treatment session. In embodiments, different cartridges 800 used in the same session may carry the same medicament, different medicaments, different dosages, and/or medicaments intended for different gingival sites.

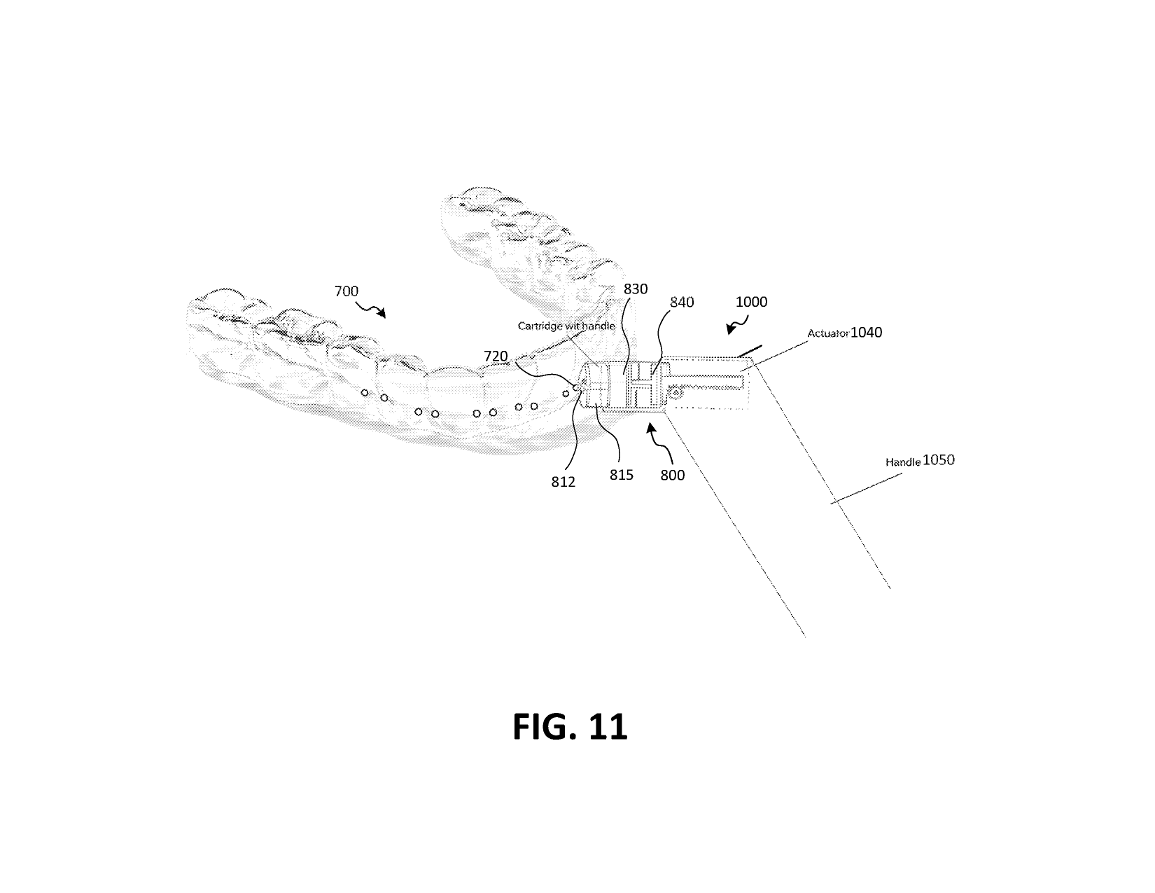

FIG. 11 illustrates an example of operations of a device 1000 for delivery of a medicament to a gingival crevice of a patient for absorption through a junctional epithelium in accordance with embodiments of the present disclosure. In embodiments, a targeting retainer 700 may be seated on the teeth of the patient such that a targeting hole 720 may be brought into alignment with a corresponding gingival crevice associated with a selected tooth location. Once the targeting retainer 700 is positioned in this manner, the system 1000, including the handle 1050, the actuator 1040, and the cartridge 800, may be brought toward the targeting retainer 700 so that the distal portion of the cartridge 800 may be aligned with a selected targeting hole 720 of the targeting retainer 700. In embodiments, the handle 1050 may provide a user with a reusable support and manipulation structure by which the cartridge 800 may be oriented and advanced in a controlled manner toward the selected targeting hole 720. Because the handle 1050 may support the cartridge 800 in a stable positional relationship, the handle 1050 may facilitate more precise guidance of the cartridge 800 than may be achievable if the cartridge 800 were manipulated directly by hand alone.

In embodiments, the handle 1050 may be used to guide the cartridge 800 until the nozzle 812 and the adjacent base 815 are brought into registration with the selected targeting hole 720. The user may then advance the cartridge 800 toward the targeting retainer 700 such that the nozzle 812 enters the selected targeting hole 720. In embodiments, the nozzle 812 may pass through the selected targeting hole 720 while the base 815 may seat within, against, or otherwise relative to the selected targeting hole 720 so as to help position and stabilize the tip of the cartridge 800 during delivery. In embodiments, the geometry of the selected targeting hole 720 and the corresponding geometry of the nozzle 812 and/or the base 815 may cooperate to guide the cartridge 800 to a desired depth and orientation.

In embodiments, once the nozzle 812 has been inserted through the selected targeting hole 720 and the cartridge 800 has been positioned for delivery, the actuator 1040 may be operated so as to engage and advance the piston 840. Advancement of the piston 840 may apply pressure to medicament contained within the reservoir 830 of the cartridge 800. In embodiments, this pressure may force the medicament from the reservoir 830 into the internal channel 820 of the cartridge 800 and subsequently out through the nozzle 812. In this manner, operation of the actuator 1040 may cause controlled extrusion of the medicament from the cartridge 800 while the distal tip of the cartridge 800 remains positioned through the selected targeting hole 720.

In embodiments, the targeting retainer 700 may ensure alignment between the cartridge 800 and the target gingival crevice by virtue of the custom-fitted relationship between the targeting retainer 700 and the dentition of the patient. For example, because the targeting retainer 700 may seat in a repeatable position on the teeth, the selected targeting hole 720 may also be repeatedly positioned in alignment with the same selected gingival crevice. As a result, insertion of the nozzle 812 through the selected targeting hole 720 may place the medicament discharge path of the cartridge 800 in a predetermined positional relationship relative to the selected gingival crevice. In embodiments, this may allow the medicament extruded from the nozzle 812 to be delivered into the selected gingival crevice, or into sufficiently close proximity thereto, such that the medicament may enter the gingival crevice and be presented to the tissues therein. In embodiments, once delivered into the gingival crevice, the medicament may be absorbed through the junctional epithelium. .

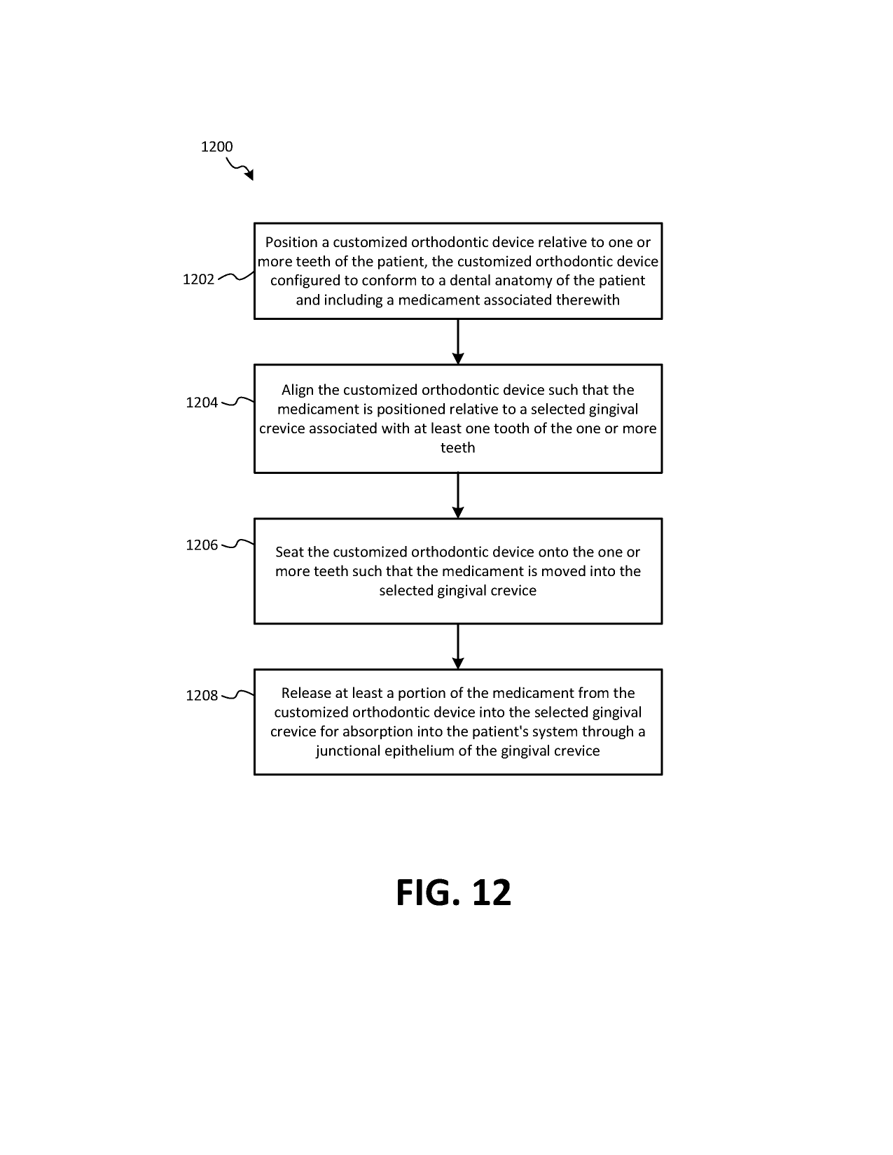

Operations for delivering a medicament to a gingival crevice of a patient using a customized orthodontic device configured in accordance with embodiments of the present disclosure will now be discussed with respect to FIG. 12. FIG. 12 shows a high-level flow diagram 1200 of operations for positioning a customized orthodontic device relative to one or more teeth of a patient, aligning the customized orthodontic device relative to a selected gingival crevice, seating the customized orthodontic device onto the one or more teeth so that the medicament is moved into the selected gingival crevice, and releasing the medicament into the selected gingival crevice for absorption into the patient’s system through a junctional epithelium of the gingival crevice.

At block 1202, a customized orthodontic device may be positioned relative to one or more teeth of the patient, the customized orthodontic device configured to conform to a dental anatomy of the patient and including a medicament associated therewith. In embodiments, the customized orthodontic device may include any of the orthodontic delivery structures described herein, including but not limited to a full-arch retainer, a partial-arch retainer, a single-tooth cap, a shell, a tray, or another customized orthodontic structure configured to fit the dentition of the patient. In embodiments, the medicament may be associated with the customized orthodontic device in a variety of ways, including being carried as a coating, a deposit, a film, a gel, a paste, a medicament seed, or being contained within a reservoir or other medicament-bearing structure of the customized orthodontic device. In embodiments, positioning the customized orthodontic device may include bringing the customized orthodontic device toward the dentition of the patient in preparation for alignment and seating relative to a selected treatment site.

At block 1204, the customized orthodontic device may be aligned such that the medicament is positioned relative to a selected gingival crevice associated with at least one tooth of the one or more teeth. In embodiments, the alignment may include orienting the customized orthodontic device so that a medicament-bearing region of the customized orthodontic device corresponds to the tooth and gingival anatomy associated with the selected gingival crevice. Because the customized orthodontic device may be custom-fitted to the dental anatomy of the patient, the geometry of the customized orthodontic device may itself facilitate this alignment. For example, once the customized orthodontic device is brought into a proper positional relationship with the dentition, the medicament associated therewith may be correspondingly brought into alignment with the selected gingival crevice. In embodiments, this may reduce the need for separate fine freehand placement of the medicament itself and may improve repeatability of medicament placement from one treatment event to another.

At block 1206, the customized orthodontic device may be seated onto the one or more teeth such that the medicament is moved into the selected gingival crevice. In embodiments, seating the customized orthodontic device may include advancing the customized orthodontic device onto the one or more teeth until the customized orthodontic device reaches a seated position determined by its custom-fitted geometry. As the customized orthodontic device is seated, the medicament associated therewith may be moved into the gingival region of the selected tooth and into the selected gingival crevice or into sufficiently close proximity thereto so as to permit delivery into the selected gingival crevice. In embodiments, seating may cause the medicament to enter the selected gingival crevice, to face the selected gingival crevice, to engage tissue adjacent the selected gingival crevice, or otherwise to communicate with the selected gingival crevice in a manner that facilitates medicament delivery. In embodiments, where the customized orthodontic device includes a reservoir, seating the customized orthodontic device may also position one or more outlet regions of the reservoir near the selected gingival crevice so that the medicament may thereafter be discharged therefrom.

At block 1208, at least a portion of the medicament may be released from the customized orthodontic device into the selected gingival crevice for absorption into the patient’s system through a junctional epithelium of the gingival crevice. In embodiments, release of the medicament may occur in a variety of ways depending on the configuration of the customized orthodontic device and the form in which the medicament is associated therewith. For example, the medicament may be released by detachment from the customized orthodontic device, by transfer from a surface of the customized orthodontic device, by diffusion, by dissolution, by flow from a reservoir, by discharge through one or more outlet regions, or by another release mechanism. In embodiments, the medicament may remain within the selected gingival crevice after removal of the customized orthodontic device, while in other embodiments the customized orthodontic device may remain seated for a period sufficient to allow at least partial release of the medicament into the selected gingival crevice before removal. In embodiments, once the medicament has been released into the selected gingival crevice, the medicament may be absorbed into the patient’s system through the junctional epithelium associated with the selected gingival crevice.

In embodiments, the medicament is configured to one or more of resist displacement from the gingival crevice due to compressive forces of gingival tissue and to be retained within a V-shaped gingival crevice by mechanical interaction with gingival tissue. In embodiments, the medicament comprises a coating disposed on at least a portion of the body.

In embodiments, insertion of the body of the customized orthodontic device into the gingival crevice transfers at least a portion of the coating into the gingival crevice. In embodiments, the medicament is dissolvable and releases medicament upon dissolution within the gingival crevice to reach junctional epithelium. In embodiments, the medicament is non-dissolvable and remains structurally intact during medicament delivery. In embodiments, the medicament is configured to remain in localized proximity to the junctional epithelium for a duration sufficient to permit absorption.

In embodiments, the medicament comprises a medicament seed having a defined physical structure. In embodiments, the medicament includes a medicament seed that comprises a semi-solid or semi-amorphous structure configured to deform and maintain position within the gingival crevice. In embodiments, the medicament is configured to conform to contours of the gingival crevice. In embodiments, the medicament increases surface area of contact with gingival tissue and the junctional epithelium.

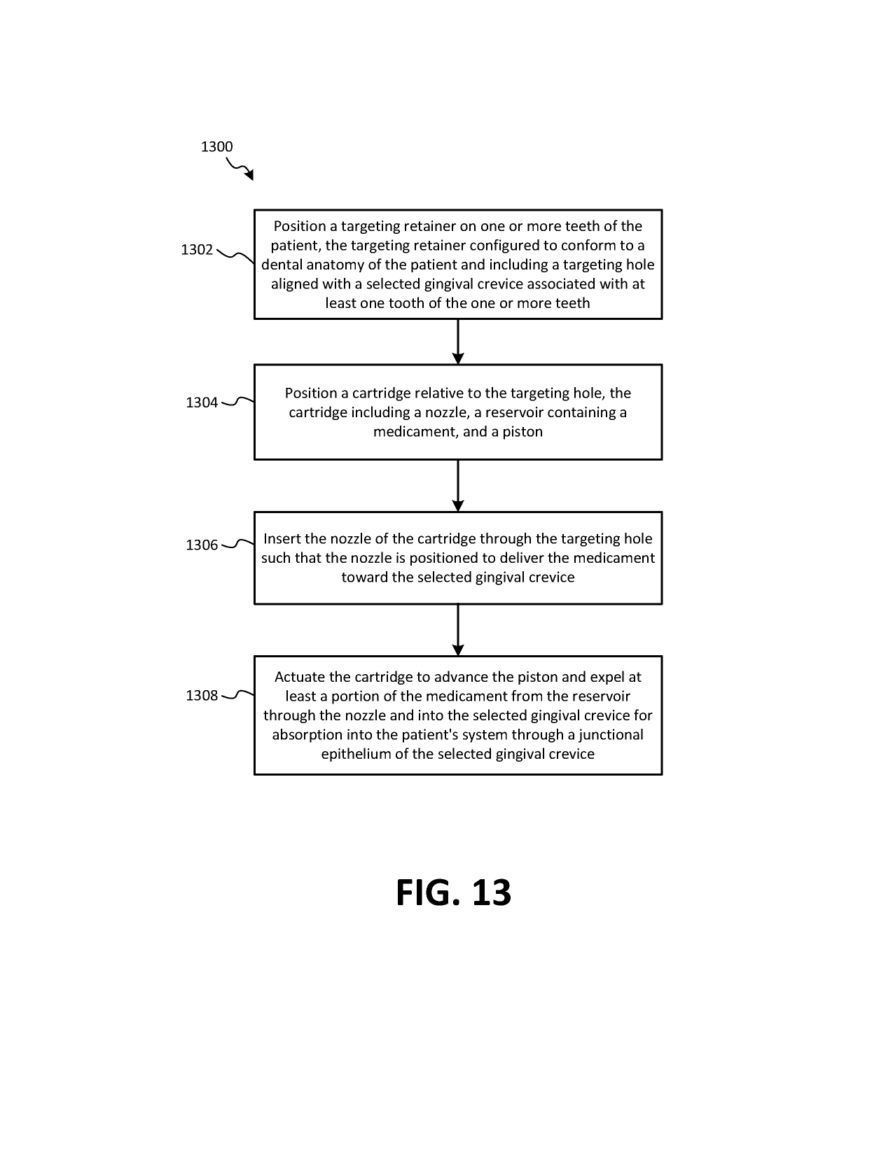

Operations for delivering a medicament to a gingival crevice of a patient using a targeting retainer and a cartridge configured in accordance with embodiments of the present disclosure will now be discussed with respect to FIG. 13. FIG. 13 shows a high-level flow diagram 1300 of operations for positioning a targeting retainer on one or more teeth of the patient, positioning a cartridge relative to a targeting hole of the targeting retainer, inserting a nozzle of the cartridge through the targeting hole, and actuating the cartridge to expel the medicament into a selected gingival crevice for absorption into the patient’s system through a junctional epithelium of the selected gingival crevice.

At block 1302, a targeting retainer may be positioned on one or more teeth of the patient, the targeting retainer configured to conform to a dental anatomy of the patient and including a targeting hole aligned with a selected gingival crevice associated with at least one tooth of the one or more teeth. In embodiments, the targeting retainer may include any of the custom-fitted targeting structures described herein, and may be fabricated based on patient-specific anatomical information so that the targeting retainer may repeatedly seat in a predictable position relative to the dentition of the patient. In embodiments, the targeting hole may correspond to a selected gingival crevice, a selected interproximal region, or another selected gingival target site. In embodiments, positioning the targeting retainer may include seating the targeting retainer on the dentition of the patient so that the targeting hole is brought into alignment with the selected gingival crevice, providing a guided access path toward the selected gingival crevice.

At block 1304, a cartridge may be positioned relative to the targeting hole, the cartridge including a nozzle, a reservoir containing a medicament, and a piston. In embodiments, the cartridge may include the cartridge structures described herein, including a tip assembly having the nozzle, a base associated with the nozzle, an internal channel in communication with the reservoir, and the piston configured to urge medicament from the reservoir. In embodiments, positioning the cartridge relative to the targeting hole may include bringing the cartridge toward the targeting retainer using a handle or other support structure so that the nozzle of the cartridge may be oriented relative to the selected targeting hole. In embodiments, the geometry of the nozzle and/or the base of the cartridge may correspond to the geometry of the targeting hole so as to facilitate alignment of the cartridge with the targeting retainer before insertion.

At block 1306, the nozzle of the cartridge may be inserted through the targeting hole such that the nozzle is positioned to deliver the medicament toward the selected gingival crevice. In embodiments, insertion of the nozzle through the targeting hole may include advancing the cartridge toward the targeting retainer until the nozzle passes through the targeting hole and the tip assembly reaches a desired depth and position relative to the selected gingival crevice (e.g., may be inserted into the gingival crevice, and/or may reach the apical aspect of the gingival crevice). In embodiments, the base of the cartridge tip may seat within, against, or otherwise relative to the targeting hole so as to help stabilize the cartridge during medicament delivery. In embodiments, the targeting hole may guide the nozzle toward the selected gingival crevice and may help maintain a desired angular and positional relationship between the cartridge and the selected gingival crevice. In this manner, insertion through the targeting hole may reduce misalignment and may facilitate more accurate medicament placement relative to the selected gingival crevice than may be achievable through freehand positioning alone.

At block 1308, the cartridge may be actuated to advance the piston and expel at least a portion of the medicament from the reservoir through the nozzle and into the selected gingival crevice for absorption into the patient’s system through a junctional epithelium of the selected gingival crevice. In embodiments, actuation of the cartridge may include applying a force to the piston directly or indirectly, such as through a handle-mounted actuator, so that the piston advances into the reservoir and urges the medicament therefrom. In embodiments, the resulting pressure may force the medicament from the reservoir into an internal channel of the cartridge and subsequently out through the nozzle. Because the nozzle may be positioned through the targeting hole and aligned relative to the selected gingival crevice, the medicament expelled from the nozzle may be delivered into the selected gingival crevice or into sufficiently close proximity thereto so as to permit entry into the selected gingival crevice. In embodiments, once the medicament has been delivered into the selected gingival crevice, the medicament may be absorbed into the patient’s system through the junctional epithelium associated with the selected gingival crevice.

In embodiments, the operations shown in FIG. 13 may be performed using a single targeting hole and a single cartridge, or may be repeated using multiple targeting holes of the same targeting retainer and one or more cartridges. In embodiments, the same medicament may be delivered through multiple targeting holes, or different medicaments may be delivered through different targeting holes. In embodiments, the cartridge may be a single-use cartridge, a disposable cartridge, a refillable cartridge, or a multi-dose cartridge, and the targeting retainer may be reused over multiple treatment sessions to repeatedly align the cartridge with the same selected gingival crevice or with multiple selected gingival crevices.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A customized orthodontic device configured for delivering a medicament into a junctional epithelium of a gingival crevice of a patient, comprising:
a body configured to conform to a dental anatomy of the patient and to be seated on one or more teeth of the patient; and
a medicament associated with the body and positioned such that, when the body is seated on the one or more teeth, the medicament is moved into a selected gingival crevice associated with at least one tooth of the one or more teeth and maintained in proximity to a junctional epithelium of the selected gingival crevice for absorption into the patient’s system through the junctional epithelium of the selected gingival crevice.

2. The customized orthodontic device of claim 1, wherein the body comprises a full-arch retainer configured to extend over a plurality of teeth of the patient.

3. The customized orthodontic device of claim 2, wherein the medicament is positioned at a selected region of the full-arch retainer corresponding to the selected gingival crevice.

4. The customized orthodontic device of claim 1, wherein the body comprises a cap configured to fit over a single tooth of the one or more teeth.

5. The customized orthodontic device of claim 4, wherein the medicament is positioned such that seating the cap on the single tooth moves the medicament into the selected gingival crevice associated with the single tooth.

6. The customized orthodontic device of claim 1, wherein the body comprises an exterior wall and an interior wall defining a reservoir therebetween, and wherein the medicament is retained within the reservoir.

7. The customized orthodontic device of claim 6, wherein the body further defines one or more outlet regions configured to be positioned within to the selected gingival crevice when the body is seated on the one or more teeth, such that the medicament is releasable from the reservoir through the one or more outlet regions into the selected gingival crevice.

8. The customized orthodontic device of claim 6, wherein the exterior wall is dissolvable such that dissolution of the exterior wall releases at least a portion of the medicament from the reservoir into the selected gingival crevice.

9. The customized orthodontic device of claim 7, wherein the one or more outlet regions are dissolvable such that dissolution of the one or more outlet regions allows the medicament to escape from the reservoir into the selected gingival crevice.

10. The customized orthodontic device of claim 1, wherein the body includes a plurality of medicament-bearing regions configured to deliver medicament to a plurality of gingival crevices associated with different teeth during a treatment session.

11. A method of delivering a medicament to a gingival crevice of a patient, the method comprising:
positioning a customized orthodontic device relative to one or more teeth of the patient, the customized orthodontic device configured to conform to a dental anatomy of the patient and including a medicament associated therewith;
aligning the customized orthodontic device such that the medicament is positioned relative to a selected gingival crevice associated with at least one tooth of the one or more teeth;
seating the customized orthodontic device onto the one or more teeth such that the medicament is moved into the selected gingival crevice; and
releasing at least a portion of the medicament from the customized orthodontic device into the selected gingival crevice for absorption into the patient’s system through a junctional epithelium of the gingival crevice.

12. The method of claim 11, wherein the customized orthodontic device comprises a full-arch retainer configured to extend over a plurality of teeth of the patient.

13. The method of claim 12, wherein the full-arch retainer includes the medicament at a selected region corresponding to the selected gingival crevice such that seating the full-arch retainer onto the plurality of teeth positions the medicament relative to the selected gingival crevice.

14. The method of claim 11, wherein the customized orthodontic device comprises a cap configured to fit over a single tooth of the one or more teeth.

15. The method of claim 14, wherein seating the cap onto the single tooth positions the medicament relative to the selected gingival crevice associated with the single tooth.

16. The method of claim 11, wherein the customized orthodontic device comprises an exterior wall and an interior wall defining a reservoir therebetween, and wherein the medicament is retained within the reservoir prior to seating the customized orthodontic device onto the one or more teeth.

17. The method of claim 16, wherein seating the customized orthodontic device onto the one or more teeth positions one or more lower outlet regions of the customized orthodontic device proximate to the selected gingival crevice such that the medicament is releasable from the reservoir into the selected gingival crevice through the one or more lower outlet regions.

18. The method of claim 16, wherein the exterior wall is dissolvable such that dissolution of the exterior wall after seating the customized orthodontic device onto the one or more teeth releases at least a portion of the medicament from the reservoir into the selected gingival crevice.

19. The method of claim 17, wherein the one or more lower outlet regions are dissolvable such that dissolution of the one or more lower outlet regions after seating the customized orthodontic device onto the one or more teeth allows the medicament to escape from the reservoir into the selected gingival crevice.

20. The method of claim 11, further comprising removing the customized orthodontic device from the one or more teeth after the releasing, while leaving at least a portion of the medicament within the selected gingival crevice.
